(19) United States
(12) Patent Application Publication
(10) Pub. No.: US 2026/0135761 A1
(43) Pub. Date: May 14, 2026

(54) METHODS FOR RADIO ACCESS NETWORK CONFIGURATION EXPOSURE AND SUBSCRIPTION

(71) Applicant: QUALCOMM Incorporated, San Diego, CA (US)

(72) Inventors: Rajeev KUMAR, San Diego, CA (US); Miguel GRIOT, La Jolla, CA (US); Gavin Bernard HORN, La Jolla, CA (US)

(21) Appl. No.: 18/946,914

(22) Filed: Nov. 13, 2024

(51) Int. Cl. H04L 41/0869

(52) U.S. Cl. CPC H04L 41/0869

(57) ABSTRACT

Methods, systems, and devices for wireless communications are described. In some implementations, a network exposure service may obtain a first request message requesting information associated with one or more radio access network (RAN) configuration states of a RAN. In some examples, a network exposure service may output, to at least a second device based at least in part on obtaining the first request message, a first response message indicating that the information associated with the one or more RAN configuration states of the RAN is supported. In such examples, the network exposure service may output based at least in part on outputting the first response message, a notification message or indication comprising a report of the one or more RAN configuration states.

### FIELD OF TECHNOLOGY

The following relates to wireless communications, including methods for radio access network configuration exposure and subscription.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity including a network exposure service is described. The method may include obtaining a first request message requesting information associated with one or more radio access network (RAN) configuration states of a RAN, outputting, to at least a second device based on obtaining the first request message, a first response message indicating that the information associated with the one or more RAN configuration states of the RAN is supported, and outputting based on outputting the first response message, a notification message or indication including a report of the one or more RAN configuration states.

A network entity including a network exposure service for wireless communications is described. The network entity including a network exposure service may include one or more memories storing processor executable code, and one or more processors coupled with the one or more memories. The one or more processors may individually or collectively be operable to execute the code to cause the network entity including a network exposure service to obtain a first request message requesting information associated with one or more RAN configuration states of a RAN, output, to at least a second device based on obtaining the first request message, a first response message indicating that the information associated with the one or more RAN configuration states of the RAN is supported, and output based on outputting the first response message, a notification message or indication including a report of the one or more RAN configuration states.

Another network entity including a network exposure service for wireless communications is described. The network entity including a network exposure service may include means for obtaining a first request message requesting information associated with one or more RAN configuration states of a RAN, means for outputting, to at least a second device based on obtaining the first request message, a first response message indicating that the information associated with the one or more RAN configuration states of the RAN is supported, and means for outputting based on outputting the first response message, a notification message or indication including a report of the one or more RAN configuration states.

A non-transitory computer-readable medium storing code for wireless communications is described. The code may include instructions executable by one or more processors to obtain a first request message requesting information associated with one or more RAN configuration states of a RAN, output, to at least a second device based on obtaining the first request message, a first response message indicating that the information associated with the one or more RAN configuration states of the RAN is supported, and output based on outputting the first response message, a notification message or indication including a report of the one or more RAN configuration states.

Some examples of the method, network entity including a network exposure services, and non-transitory computer-readable medium described herein may further include operations, features, means, or instructions for outputting, to a second network entity including a subscription service based on obtaining the first request message from a user equipment (UE), a subscription request message including a first identifier associated with the UE, and an indication that notification of the one or more RAN configuration states may be requested by the UE and obtaining, from the second network entity based on outputting the subscription request message, a subscription response message including the first identifier and including subscription permission information corresponding to at least one of the one or more RAN configuration states, where outputting the first response message may be based on the subscription response message.

Some examples of the method, network entity including a network exposure services, and non-transitory computer-readable medium described herein may further include operations, features, means, or instructions for obtaining, from the second device including a UE, a registration message including a request to establish service for the UE, outputting, based on obtaining the registration message, a security setup request message to a third network entity including a security service, obtaining, from the third network entity based on outputting the security setup request message, security context information, and outputting the security context information to a UE, where obtaining the first request message may be based on outputting the security context information.

Some examples of the method, network entity including a network exposure services, and non-transitory computer-readable medium described herein may further include operations, features, means, or instructions for outputting, to the RAN based on obtaining the subscription response message, an activation request message corresponding to the one or more RAN configuration states and obtaining, from the RAN based on the activation request message, an activation response message for at least one of the one or more RAN configuration states, where outputting the first response message may be based on the activation response message, and where the second device includes a UE.

Some examples of the method, network entity including a network exposure services, and non-transitory computer-readable medium described herein may further include operations, features, means, or instructions for outputting, to a second network entity and based on obtaining the first request message, subscription information corresponding to a UE, the second network entity including an access and mobility service (AMS) and obtaining, from the second network entity based on outputting the subscription information, subscription notification information corresponding to the one or more RAN configuration states and including a second identifier corresponding to the RAN.

Some examples of the method, network entity including a network exposure services, and non-transitory computer-readable medium described herein may further include operations, features, means, or instructions for outputting, to the RAN based on the second identifier, a second request message requesting the information associated with the one or more RAN configuration states of the RAN and obtaining, from the RAN based on outputting the second request message to at least the second device, a second response message indicating that the information associated with the one or more RAN configuration states of the RAN may be supported, where the second device includes the UE, and where outputting the first response message to the UE may be based on obtaining the second response message from the RAN.

Some examples of the method, network entity including a network exposure services, and non-transitory computer-readable medium described herein may further include operations, features, means, or instructions for obtaining, from the RAN based on outputting the first response message, an indication of the report of the one or more RAN configuration states, where outputting the notification message or indication may be based on obtaining the indication of the report.

In some examples of the method, network entity including a network exposure services, and non-transitory computer-readable medium described herein, the second device includes the UE, outputting the first response message to the UE includes outputting the first response message to the UE via an application function (AF) or a network function (NF), a network exposure service, or any combination thereof, and outputting the first response message may be based on obtaining a second response message from the RAN indicating that the information associated with the one or more RAN configuration states of the RAN may be supported.

In some examples of the method, network entity including a network exposure services, and non-transitory computer-readable medium described herein, the one or more RAN configuration states include a codebook index, an antenna configuration, a beam shape, one or more mobility parameters, a cell activation state, a cell deactivation state, a RAN loading configuration, or any combination thereof.

In some examples of the method, network entity including a network exposure services, and non-transitory computer-readable medium described herein, the one or more RAN configuration states include RAN operation parameters, RAN status information, or both.

A method for wireless communications by a UE is described. The method may include transmitting, to a network entity, a first request message requesting information associated with one or more RAN configuration states of a RAN and receiving, from the network entity based on transmitting the first request message, a first response message indicating that the information associated with the one or more RAN configuration states of the RAN is supported.

A UE for wireless communications is described. The UE may include one or more memories storing processor executable code, and one or more processors coupled with the one or more memories. The one or more processors may individually or collectively be operable to execute the code to cause the UE to transmit, to a network entity, a first request message requesting information associated with one or more RAN configuration states of a RAN and receive, from the network entity based on transmitting the first request message, a first response message indicating that the information associated with the one or more RAN configuration states of the RAN is supported.

Another UE for wireless communications is described. The UE may include means for transmitting, to a network entity, a first request message requesting information associated with one or more RAN configuration states of a RAN and means for receiving, from the network entity based on transmitting the first request message, a first response message indicating that the information associated with the one or more RAN configuration states of the RAN is supported.

A non-transitory computer-readable medium storing code for wireless communications is described. The code may include instructions executable by one or more processors to transmit, to a network entity, a first request message requesting information associated with one or more RAN configuration states of a RAN and receive, from the network entity based on transmitting the first request message, a first response message indicating that the information associated with the one or more RAN configuration states of the RAN is supported.

Some examples of the method, UEs, and non-transitory computer-readable medium described herein may further include operations, features, means, or instructions for receiving, based on receiving the first response message, a notification message or indication including a report of the one or more RAN configuration states.

In some examples of the method, UEs, and non-transitory computer-readable medium described herein, the first request message requests the information associated with a set of multiple RAN configuration states of the RAN, and the first response message indicates that a subset of the set of multiple RAN configuration states may be supported.

Some examples of the method, UEs, and non-transitory computer-readable medium described herein may further include operations, features, means, or instructions for determining the one or more RAN configuration states of the RAN based on one or more conditions at the UE, where transmitting the first request message may be based on the determining.

In some examples of the method, UEs, and non-transitory computer-readable medium described herein, the one or more RAN configuration states include a codebook index, an antenna configuration, a beam shape, one or more mobility parameters, a cell activation state, a cell deactivation state, a RAN loading configuration, or any combination thereof.

In some examples of the method, UEs, and non-transitory computer-readable medium described herein, the network entity includes a RAN, a RAN exposure service, a network exposure service, a subscription service, an AMS, or any combination thereof.

Some examples of the method, UEs, and non-transitory computer-readable medium described herein may further include operations, features, means, or instructions for transmitting a registration message including a request to establish service for the UE and receiving, based on transmitting the registration message, security context information, where transmitting the first request message may be based on outputting the security context information.

In some examples of the method, UEs, and non-transitory computer-readable medium described herein, the one or more RAN configuration states include RAN operation parameters, RAN status information, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports methods for radio access network (RAN) configuration exposure and subscription in accordance with one or more aspects of the present disclosure.

FIG. 2 shows an example of a wireless communications system that supports methods for RAN configuration exposure and subscription in accordance with one or more aspects of the present disclosure.

FIG. 3 shows an example of a process flow that supports methods for RAN configuration exposure and subscription in accordance with one or more aspects of the present disclosure.

FIG. 4 shows an example of a process flow that supports methods for RAN configuration exposure and subscription in accordance with one or more aspects of the present disclosure.

FIG. 5 shows an example of a process flow that supports methods for RAN configuration exposure and subscription in accordance with one or more aspects of the present disclosure.

FIG. 6 shows an example of a process flow that supports methods for RAN configuration exposure and subscription in accordance with one or more aspects of the present disclosure.

FIG. 7 shows an example of a process flow that supports methods for RAN configuration exposure and subscription in accordance with one or more aspects of the present disclosure.

FIG. 8 shows an example of a process flow that supports methods for RAN configuration exposure and subscription in accordance with one or more aspects of the present disclosure.

FIG. 9 shows an example of a process flow that supports methods for RAN configuration exposure and subscription in accordance with one or more aspects of the present disclosure.

FIG. 10 shows an example of a process flow that supports methods for RAN configuration exposure and subscription in accordance with one or more aspects of the present disclosure.

FIGS. 11 and 12 show block diagrams of devices that support methods for RAN configuration exposure and subscription in accordance with one or more aspects of the present disclosure.

FIG. 13 shows a block diagram of a communications manager that supports methods for RAN configuration exposure and subscription in accordance with one or more aspects of the present disclosure.

FIG. 14 shows a diagram of a system including a device that supports methods for RAN configuration exposure and subscription in accordance with one or more aspects of the present disclosure.

FIGS. 15 and 16 show block diagrams of devices that support methods for RAN configuration exposure and subscription in accordance with one or more aspects of the present disclosure.

FIG. 17 shows a block diagram of a communications manager that supports methods for RAN configuration exposure and subscription in accordance with one or more aspects of the present disclosure.

FIG. 18 shows a diagram of a system including a device that supports methods for RAN configuration exposure and subscription in accordance with one or more aspects of the present disclosure.

FIGS. 19 through 23 show flowcharts illustrating methods that support methods for RAN configuration exposure and subscription in accordance with one or more aspects of the present disclosure.

### DETAILED DESCRIPTION

In some wireless communications systems, a radio access network (RAN) may perform wireless communications in accordance with one or more configuration statuses (e.g., operating parameters or status information, RAN configurations, RAN events, or RAN statuses, among other examples) of the RAN. For example, the RAN configurations may include one or more codebook indexes, one or more antenna configurations, one or more beams used by one or more network entities of the RAN, one or more mobility parameters, a cell activation or deactivation state, a RAN loading parameter (e.g., a physical resource block (PRB) usage), or any combination thereof, among other examples. Access to such information may be beneficial to one or more user equipments (UE). However, some RAN configuration statuses may not be accessible to the UE (e.g., indicated to the UE or otherwise determined by the UE). For instance, the UE may not be subscribed to one or more services, in which case various RAN entities may not provide information regarding current configuration statuses or updated configuration statuses.

In some cases, one or more RAN configurations may change. Some such RAN configurations may be applicable to (e.g., may impact) one or more aspects of wireless communications at the UE. For example, the UE may more efficiently perform device management in accordance with such RAN configurations (e.g., including events, statuses, etc.). Such UE-specific device management may include device life cycle management (LCM) procedures, offline training for the device (e.g., UE model training may be performed based at least in part on the RAN configurations), model management for the UE (e.g., management of RAN configuration dependent UE models at the UE), uplink traffic shaping or control at the UE, or other procedures. However, some such RAN configurations may occur at one or more RAN services which may not autonomously provide updated information, or the UE may not be subscribed to some such RAN services, in which case updated information may not be provided to the UE. Without access to such information, the UE may be less efficient in performing device management (e.g., which may result in poor LCM, ineffective or failed ML model training and management, inability to leverage efficiency improvements resulting from ML models, among other examples).

Techniques described herein may support RAN configuration exposure and subscription. In some implementations, the RAN (e.g., the RAN, or a RAN exposure service) may provide an indication to the UE indicating the one or more RAN configurations or updated RAN configuration statuses. In some examples, the UE may transmit a request message requesting the RAN to provide an indication of a set of RAN configurations. Additionally, or alternatively, a RAN exposure service may coordinate with one or more additional subscribing entities (e.g., a model training logical function (MTLF), a network data analytic function (NWDAF), or extended reality (XR) services, among other examples) to request notification of a set of RAN configurations for the UE. For example, a RAN exposure service may receive a RAN configuration notification request message indicating one or more RAN configuration statuses requested by the UE (e.g., from a UE, from an application function (AF) or network function (NF), or the like), and may coordinate with one or more network services (e.g., an access and mobility service (AMS), RAN, security service, subscription service, network exposure service, etc.) to obtain the relevant RAN configuration statuses (e.g., permissions or subscriptions to the configuration statuses, or an indication of which configuration statuses are supported for RAN configuration status exposure). The RAN exposure service may then provide a RAN configuration subscription response message (e.g., to the UE, the AF or NF, or the like) indicating the configuration statuses requested by the UE (e.g., if RAN configuration exposure is supported for the requested configuration statuses).

The RAN exposure service may subsequently provide reports notifying the UE of any updates to the indicated RAN configuration statuses. For example, one or more RAN configurations of a set of RAN configurations (e.g., indicated by the RAN configuration subscription response) may satisfy (e.g., meet) a reporting condition. For example, one of the RAN configurations may change, which may satisfy a reporting condition. In such examples, the RAN may output an indication to the UE (e.g., subscribing entity) including the set of RAN configurations (e.g., a set of currently configured RAN configurations or updates to the currently configured RAN configurations).

Aspects of the disclosure are initially described in the context of wireless communications systems. Aspects of the disclosure are further described in the context of wireless communication systems and process flows. Aspects of the disclosure are further illustrated by and described with reference to apparatus diagrams, system diagrams, and flowcharts that relate to methods for radio access network configuration exposure and subscription.

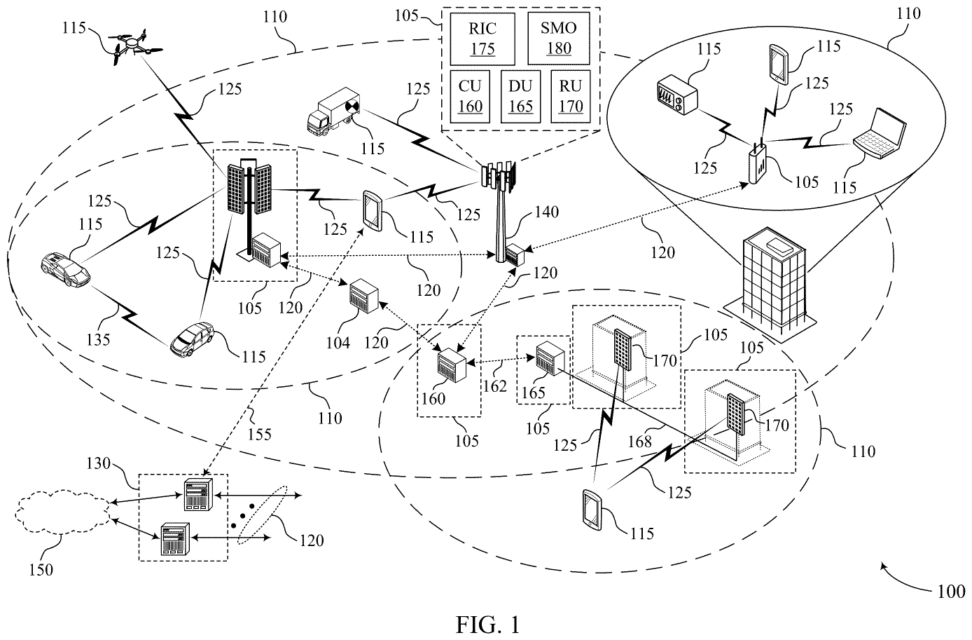

FIG. 1 shows an example of a wireless communications system 100 that supports methods for radio access network configuration exposure and subscription in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support methods for radio access network configuration exposure and subscription as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein may support RAN configuration exposure and subscription. In some implementations, the RAN (e.g., the RAN, or a RAN exposure service) may provide an indication to the UE including the one or more RAN configurations or updated RAN configuration statuses. In some examples, the UE may transmit a request message requesting the RAN to provide an indication including a set of RAN configurations. Additionally, or alternatively, a RAN exposure service may coordinate with one or more additional subscribing entities (e.g., a MTLF, a NWDAF, or XR services, among other examples) to request notification of a set of RAN configurations for the UE. For example, a RAN exposure service may receive a RAN configuration notification request message indicating one or more RAN configuration statuses requested by the UE (e.g., from a UE, from a AF, or from a NF, or the like), and may coordinate with one or more network services (e.g., an AMS, RAN, security service, subscription service, network exposure service, etc.) to obtain the relevant RAN configuration statuses (e.g., permissions or subscriptions to the configuration statuses, or an indication of which configuration statuses are supported for RAN configuration status exposure). The RAN exposure service may then provide a RAN configuration subscription response message (e.g., to the UE, the AF or NF, or the like) indicating the configuration statuses requested by the UE (e.g., if RAN configuration exposure is supported for the requested configuration statuses).

The RAN exposure service may subsequently provide reports notifying the UE of any updates to the indicated RAN configuration statuses. For example, one or more RAN configurations of a set of RAN configurations (e.g., indicated by the RAN configuration subscription response) may satisfy (e.g., meet) a reporting condition. For example, one of the RAN configurations may change, which may satisfy a reporting condition. In such examples, the RAN may transmit an indication to the UE (e.g., subscribing entity) including the set of RAN configurations (e.g., a set of currently configured RAN configurations or updates to the currently configured RAN configurations).

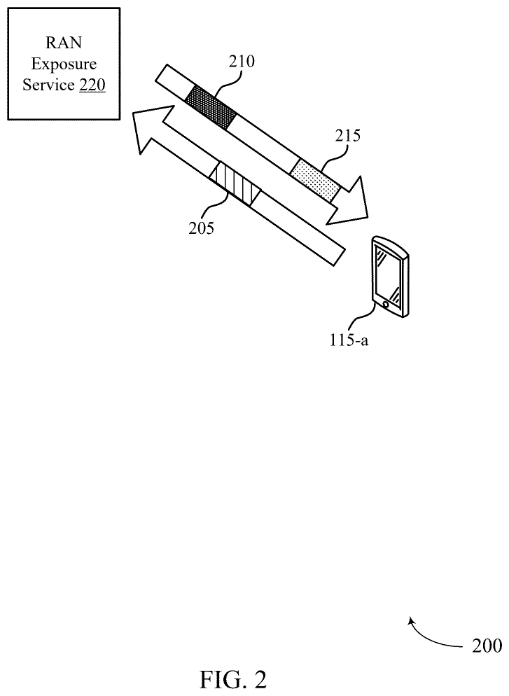

FIG. 2 shows an example of a wireless communications system 200 that supports methods for radio access network configuration exposure and subscription in accordance with one or more aspects of the present disclosure. In some implementations, the wireless communications system 200 may implement or be implemented by aspects of the wireless communications system 100. For example, the wireless communications system 200 may include a network entity comprising a RAN exposure service 220 (e.g., which may be an example of the network entity 105, among other devices and network functions) and a UE 115-a, which may be examples of the network entity 105 and the UE 115 respectively.

In some cases, a RAN may operate according to multiple RAN configurations. As described herein, the term RAN configuration may refer RAN operating parameters or status information, RAN configurations, RAN events, or RAN statuses, among other examples. For example, the RAN configurations may include an indication of one or more codebook indexes, one or more antenna configurations, one or more beam shapes (e.g., beams used by a gNB), one or more mobility parameters (e.g., parameters associated with UE mobility), a cell activation or cell deactivation indicator, a RAN loading, or other network configurations. In some cases, the UE 115-a may utilize the one or more RAN configurations to adjust one or more configurations of the UE 115-a (e.g., to adjust the performance of the UE) by performing one or more functions. For example, the UE 115-a may utilize the one or more RAN configurations for device LCM procedures, offline training for the UE 115-a (e.g., UE model training may be performed based at least in part on the RAN configurations), model management for the UE 115-a (e.g., management of RAN configuration-based UE models at the UE 115-a), uplink traffic shaping or control at the UE 115-a, or other procedures. However, without access to such RAN configuration information, the UE 115-a may not be able to perform some or all such procedures.

Techniques described herein may enable the RAN to expose (e.g., signal or indicate) the RAN configurations (e.g., RAN configuration states or statuses) to one or more subscribing devices. For example, the subscribing devices may include the UE 115-a, one or more other subscribing entities or services (e.g., MTLF, NWDAF, or XR services), or any combination thereof. In some implementations, the RAN may expose the RAN configurations directly to the UE 115-a. In such implementations, the UE 115-a may transmit a request (e.g., a request message) to the RAN requesting to be notified of a set of RAN configurations (e.g., indicating a list of RAN configurations for which the UE 115-a requests notification). Accordingly, in some examples, the RAN may determine whether the UE is authorized to access (e.g., receive an indication of) the set of RAN configurations. The RAN may provide a response message indicating which (e.g., or all) of the requested RAN configurations the UE is authorized to receive the requested information. In some examples, the RAN may output an indication including the set of RAN configurations (e.g., the set of supported RAN configurations) based on at least one of the RAN configurations satisfying (e.g., meeting) a reporting condition. For example, the RAN may send (e.g., output) an indication of the set of RAN configurations upon meeting a requested RAN configuration, reporting event, or RAN statuses.

Additionally, or alternatively, in some implementations, the RAN may expose the RAN configurations via the RAN exposure service 220 (e.g., a network entity performing functions as a RAN exposure service). In such implementations, the UE 115-a may transmit a request message 205 requesting notification of a set of RAN configurations. Additionally, or alternatively, the RAN exposure service 220 (e.g., the UE 115-a, the RAN, or both, via one or more additional network functions or services) may determine whether the UE is allowed to access the set of RAN configurations. In such examples, if the UE is allowed to access the set of RAN configurations, the RAN exposure service 220 may output a response message 210 indicating that RAN configuration exposure is supported (e.g., for at least the set of RAN configurations). Additionally, or alternatively, the RAN exposure service 220 may output the response message 210 indicating a portion of the RAN configurations (e.g., a subset, or list) that are supported (e.g., a subset of RAN configurations that the UE 115-b is authorized to access and that are supported by the RAN). Accordingly, in some examples, the RAN exposure service 220 may output an indication message 215 (e.g., a report, or a notification or indication, among other examples) indicating the RAN configurations based on at least one of the RAN configurations satisfying a reporting condition. For example, the RAN exposure service 220 may output the indication message 215 based on one of the configurations of the set of RAN configurations changing. Additionally, or alternatively, the RAN exposure service 220 may output the indication message 215 based on the UE 115-a requesting the notification of the RAN configurations (e.g., the RAN exposure service 220 may indicate a current set of RAN configurations based on the UE 115-a requesting an indication of the current RAN configurations). As described herein, the indication message 215 may also be referred to as a notification or indication, a notification message, an indication message, or the like.

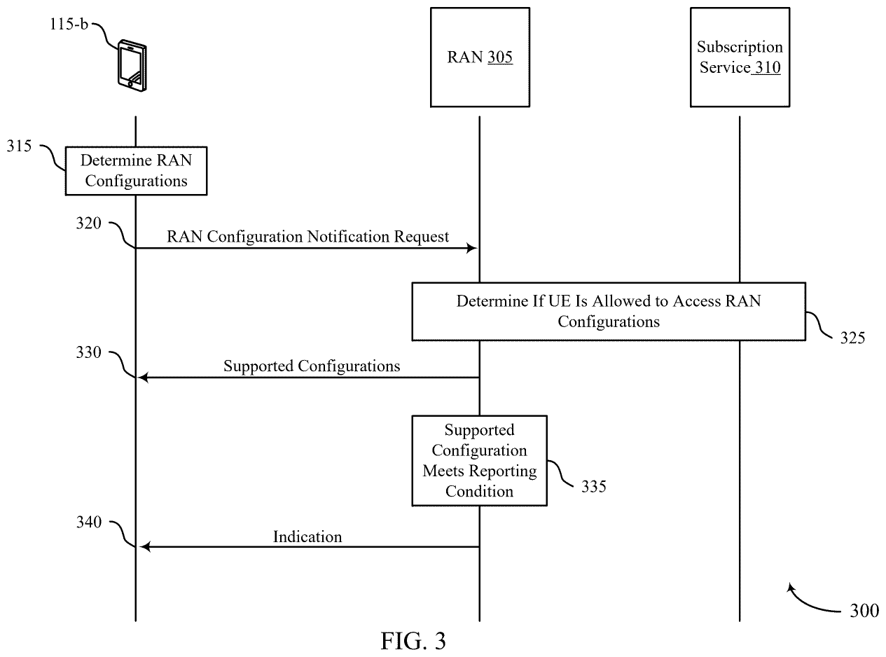

In some implementations further described herein with reference to FIGS. 3-6, the RAN may be included within (e.g., be a part of) a service-based architecture (SBA). In such examples, services (e.g., the RAN exposure service 220, among other services) may subscribe to (e.g., request notification from) an AMF or an access and mobility service (AMS) to get notified when UE 115-a comes to connected state (e.g., connects to the RAN). Additionally, or alternatively, the RAN exposure service 220 or other services may subscribe (e.g., directly subscribe to the RAN) to exposure of RAN configurations, RAN status, or RAN events. In such examples, the RAN may expose subscribed events (e.g., indicating RAN configurations or RAN statuses) to the UE 115-a, the RAN exposure service 220, or other subscribing services.

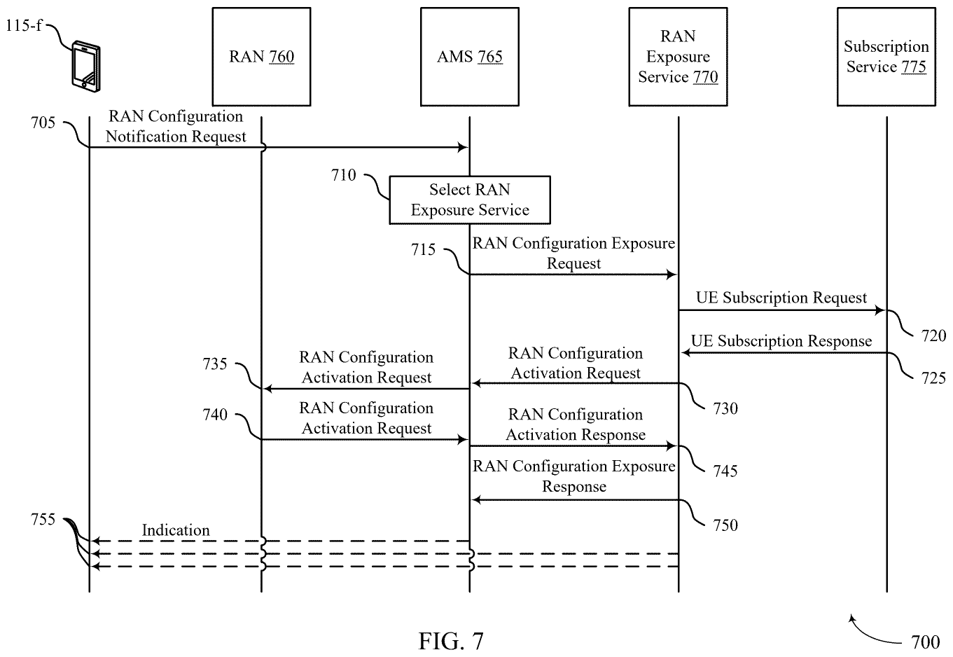

In some other implementations further described herein with reference to FIGS. 7-10, the RAN may not be included within the SBA (e.g., is not a part of the SBA). In such examples, the UE 115-a or other services may subscribe to the AMF or the AMS for notification of RAN configurations (e.g., RAN events, or RAN statuses). In such examples, the AMS may configure (e.g., instruct or request) the RAN to report or indicate the RAN configurations, RAN events, or RAN statuses using one or more transport layer services (e.g., N2 services or N1N2 services) or other application or transport layer protocols. Accordingly, in such examples, the AMF or AMS may expose subscribed (e.g., requested) RAN configurations, RAN events, or RAN statuses to the UE 115-a or other services. Additionally, or alternatively, an operation and maintenance (OAM) function or a service management and orchestration (SMO) function may expose the RAN configurations (e.g., rather than the AMF or AMS).

Additionally, or alternatively, the request message 205, the response message 210, the indication message 215, or any combination thereof may be control signaling such as downlink control information (DCI) messages, radio resource control (RRC) messages, MAC control elements (MAC-CEs), other control signaling, or any combination thereof.

Additionally, or alternatively, the request message 205, the response message 210, the indication message 215, or any combination thereof may utilize one or more signaling protocols. For example, the wireless communications system 200 may utilize a protocol (e.g., a generic NAS or user plane protocol) for communications between the RAN and other core network services (e.g., for requesting RAN configurations, RAN statuses, and RAN events from a service to RAN or providing configured RAN configurations, RAN statuses, and RAN events from RAN to a service). In some examples, the RAN exposure service 220 may utilize a protocol similar to or based on a NR positioning protocol (LPP) (e.g., a protocol similar to and with a relatively reduced complexity than LPP) to indicate a set of RAN configurations to the UE 115-a. Additionally, or alternatively, the wireless communications system 200 may utilize one or more control plane or user plane protocols to perform communications between the RAN and one or more network services.

In some implementations such as when the RAN is not included within the SBA (e.g., such as the examples described herein with reference to FIGS. 7-10), the wireless communications system 200 may utilize one or more protocols (e.g., generic protocols between the RAN and one or more other core network services) to enable communications between the RAN and the AMS. For an example, the RAN and the AMS may communicate using a protocol similar to a NR positioning protocol A (NRPPa) (e.g., a protocol similar to and with a relatively reduced complexity than NRPPa). Additionally, or alternatively, one or more functions of the AMS (e.g., Namf_Communication_N1MessageNotify, Namf_Communication_N1N2MessageSubscribe, Namf_Communication_N2InfoSubscribe, or Namf_Communication_N2InfoNotify, among other examples), may be utilized to expose RAN configurations, RAN statuses, or RAN events to requesting network exposure functions (NEFs), network services, or application functions, among other network functions. For example, the one or more functions may enable an event exposer related to RAN configuration or RAN statuses.

FIG. 3 shows an example of a process flow 300 that supports methods for radio access network configuration exposure and subscription in accordance with one or more aspects of the present disclosure. In some implementations, the process flow 300 may implement or be implemented by aspects of the wireless communications system 100 and the wireless communications system 200. For example, the process flow 300 may include a UE 115-b, which may be an example of the UE 115. The process flow 300 may additionally include a RAN 305RAN 305 and a subscription service 310.

At 315, the UE 115-a may identify (e.g., determine) a set of RAN configurations for which the UE 115-b is requesting notifications (e.g., a list of RAN configuration, RAN events, or RAN statuses for which exposure information is to be requested from the RAN). For example, the RAN configurations may be identified based on the UE 115-b one or more operations that may benefit from information provided by the RAN configurations.

At 320, the UE 115-a may transmit, and the RAN 305 may obtain, a request message (e.g., a RAN configuration notification request) requesting notification of the set of RAN configurations. In some examples, the request message may include an indication of each of the set of RAN configurations.

At 325, the RAN 305 may determine (e.g., via the subscription service 310), whether the set of RAN configurations are authorized for exposure to the UE 115-b (e.g., whether the UE 115-b is authorized to receive the requested information). For example, the RAN 305 may communicate with the subscription service 310 to determine which RAN configurations of the set of RAN configurations are authorized for exposure. In some examples, at 330, the RAN 305 may output, and the UE 115-b may receive, an indication of the RAN configurations authorized for exposure (e.g., a RAN configuration notification response message). For example, the RAN 305 may indicate a list of RAN configurations authorized for exposure that is a subset of (e.g., or includes all of) the RAN configurations requested by the UE 115-b.

At 335, at least one RAN configuration of the set of RAN configurations authorized for exposure may satisfy a reporting condition. For example, one RAN configuration of the set of RAN configurations authorized for exposure or a RAN status may change, or a RAN event may occur (e.g., the RAN may switch an antenna configuration or beam configuration, or may update a codebook index, among other examples). In such examples, at 340, the RAN 305 may output, and the UE 115-b may receive, an indication (e.g., a report, or indication, among other examples) including the set of RAN configurations based on at least one of the RAN configurations satisfying the reporting condition. In such examples, the indication may include a state of each of the RAN configurations of the set of supported RAN configurations, or may include an indication of one or more of the RAN configurations for which the reporting conditions were satisfied.

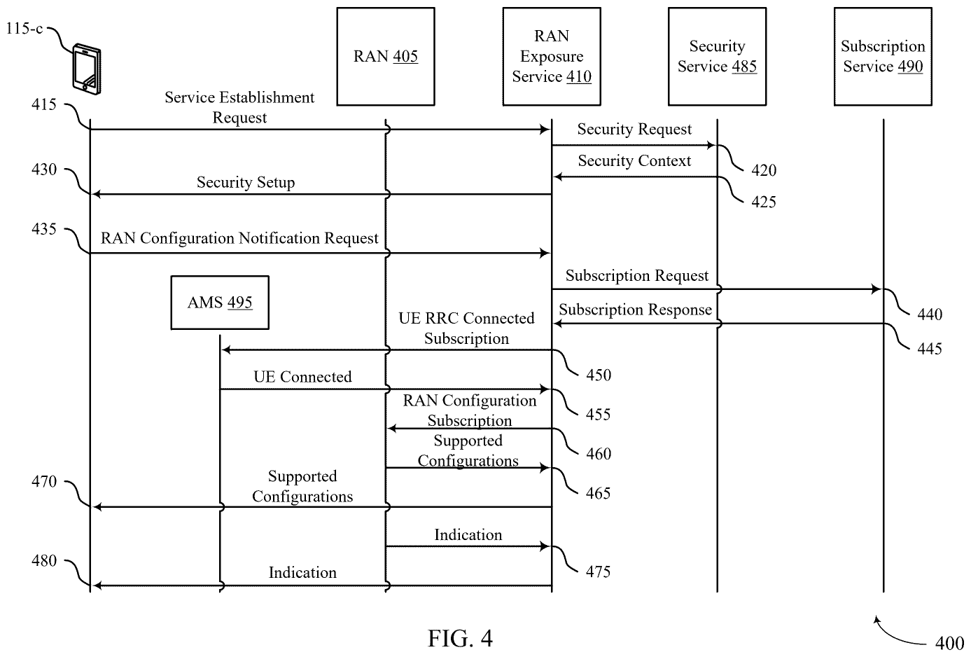

FIG. 4 shows an example of a process flow 400 that supports methods for radio access network configuration exposure and subscription in accordance with one or more aspects of the present disclosure. In some implementations, the process flow 400 may implement or be implemented by aspects of the wireless communications system 100 and the wireless communications system 200. For example, the process flow 400 may include a UE 115-c, which may be an example of the UE 115. The process flow 400 may additionally include a RAN 405, a RAN exposure service 410, a security service 485, a subscription service 490, and an AMS 495.

At 415, the UE 115-c may transmit a registration message (e.g., service establishment request message). In some examples, the UE 115-c may transmit the registration message to the RAN exposure service 410. Accordingly, at 420, the RAN exposure service 410 may output (e.g., forward) the registration message to the security service 485.

At 425, the security service 485 may output an indication of a security context (e.g., a set supported of parameters or conditions for the UE 115-c to operate). In some examples, the security service 485 may output the indication of the security context to the RAN exposure service 410. Accordingly, at 430, the RAN exposure service 410 may output (e.g., forward) the indication of the security context to the UE 115-c. In such examples, the RAN exposure service 410 and the UE 115-c may perform a security setup procedure.

At 435, the UE 115-c may transmit a configuration notification request (e.g., RAN configuration notification request message) requesting notification of a set of RAN configurations. In some examples, the configuration notification request may include an indication of a set of RAN configurations that may be identified (e.g., by the UE 115-c) based on the UE 115-c utilizing the RAN configurations to perform (e.g., adjusting one or more configurations of) one or more functions at the UE 115-c.

At 440, the RAN exposure service 410 may transmit a subscription request message (e.g., a UE subscription request message) to the subscription service 490 (e.g., to check with the subscription service 490) to determine whether the UE is authorized to access the set of RAN configurations. For example, the subscription request may include an indication of the set of RAN configurations that the UE 115-c is authorized to access. Accordingly, the subscription service 490 may determine a set of supported (e.g., allowable) RAN configurations (e.g., the subscription service 490 may determine which RAN configurations of the set of RAN configurations the UE 115-c may be allowed to access). At 445, the subscription service 490 may output a subscription response message (e.g., a UE subscription response message) to the RAN exposure service 410 indicating the set of allowed RAN configurations. Additionally, or alternatively, the subscription response may also include a set of non-allowed RAN configurations.

At 450, the UE 115-c may output a subscription message (e.g., UE RRC connected subscription) to the AMS 495. The subscription message may request notification of when the UE 115-c establishes a connection (e.g., to get notified when the UE 115-c, or a list of UEs including the UE 115-c, enters an RRC connected state). In such examples, at 455, the AMS 495 may output an indication of a UE connected state (e.g., when the UE 115-c establishes or has established a connection) to the RAN exposure service 410. In some examples, the indication may include an indication of a RAN identifier (ID) associated with the RAN connected to the UE 115-c (e.g., the RAN 405). For example, based on the UE 115-c connecting, the AMS 495 may notify the RAN exposure service 410 with the RAN ID.

At 460, based on receiving the indication of the RAN ID (e.g., the indication of the UE RRC connected state), the RAN exposure service 410 may output a RAN configuration notification subscription message to the RAN 405 (e.g., the RAN exposure service 410 may subscribe to the RAN 405 or may request subscription to the RAN 405 on behalf of the UE 115-c). In some examples, the RAN configuration subscription message may include an indication of the RAN configurations authorized for exposure (e.g., the RAN configurations authorized for exposure indicated by the subscription service 490).

At 465, the RAN 405 may output an indication of a set of RAN configurations authorized for exposure (e.g., a RAN configuration notification subscription response message) based at least in part on receiving the RAN configuration subscription. In some examples, the set of RAN configurations authorized for exposure may be a set of RAN configurations supported by the RAN 405, and may be a subset of the RAN configurations allowed for the UE 115-c to access (e.g., based on the RAN 405 supporting the configurations). Additionally, or alternatively, the indication may include an indication of one or more RAN events, RAN status exposures, or both. At 470, the RAN exposure service 410 may, based on receiving the indication of the set of RAN configurations authorized for exposure, output (e.g., forward), an indication of the set of RAN configurations authorized for exposure (e.g., the RAN configuration notification response message) to the UE 115-c.

In some implementations, at least one RAN configuration of the set of RAN configurations authorized for exposure may satisfy a reporting condition (e.g., meeting the requested RAN configuration, RAN event, or RAN status exposure). For example, one RAN configuration of the set of RAN configurations authorized for exposure or a RAN status may change, or a RAN event may occur. In such examples, at 475, the RAN 405 may output, and the RAN exposure service 410 may receive, an indication (e.g., a report) including one or more RAN configurations of the set of RAN configurations based on at least one of the RAN configurations satisfying the reporting condition. In such examples, the indication may include a state of each of the RAN configurations of the set of RAN configurations authorized for exposure, or may include an indication of one or more of the RAN configurations for which the reporting conditions were satisfied.

At 480, based on receiving the indication, the RAN exposure service 410 may output (e.g., forward) the indication to the UE 115-c. In such examples, the indication may include a state of each of the RAN configurations of the set of RAN configurations authorized for exposure, or may include an indication of one or more of the RAN configurations for which the reporting conditions were satisfied.

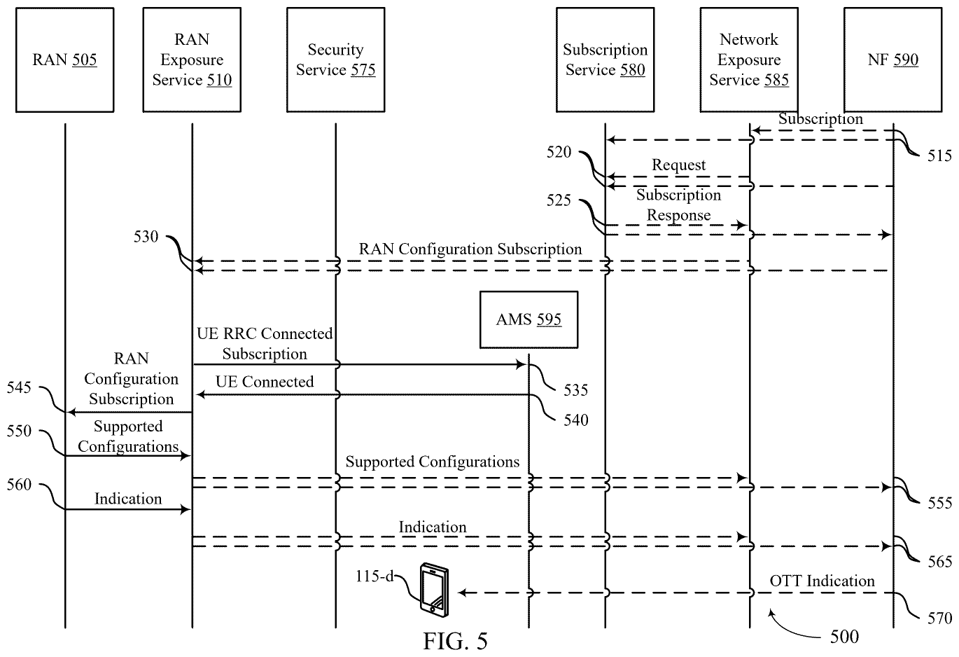

FIG. 5 shows an example of a process flow 500 that supports methods for radio access network configuration exposure and subscription in accordance with one or more aspects of the present disclosure. In some implementations, the process flow 500 may implement or be implemented by aspects of the wireless communications system 100 and the wireless communications system 200. For example, the process flow 500 may include a UE 115-d, which may be an example of the UE 115. The process flow 500 may further include a RAN 505, a RAN exposure service 510, a security service 575, a subscription service 580, a network exposure service 585, a network function (NF) 590 (e.g., which may be an example of an AF, an NF, or both, and which may be collocated with, separate from, or may exist within or on top of, the UE 115-d), and an AMS 595.

At 515, the NF 590 may output a subscription message to the network exposure service 585, the subscription service 580 or both. For example, in some implementations, the NF 590 may output the subscription message to the subscription service 580 directly based on the NF 590 being part of a trusted domain. In some other examples described herein, the functions performed by the NF 590 may be performed by the network exposure service 585 (e.g., instead of the NF 590) based on the NF 590 being part of an untrusted domain (e.g., communications and functions may be operated by the trusted network exposure service 585 instead). For example, where the NF 590 is part of an untrusted domain, the NF 590 may output the subscription message to the network exposure service 585, and the network exposure service 585 may correspondingly forward the subscription message to one or more other network services.

At 520, the NF 590, the network exposure service 585 (e.g., based on receiving the subscription message of 515 from the NF 590), or both may output a subscription request message. For example, the subscription request message may include an indication of a set of RAN configurations requested by the NF 590 (e.g., requested by the UE 115-d via the NF 590, or by the NF 590 for the UE 115-d). In some examples, the subscription service 580 may determine a set of allowable (e.g., supported) RAN configurations (e.g., the subscription service 580 may determine which RAN configurations of the set of RAN configurations the UE 115-d may be allowed to access). Additionally, or alternatively, the subscription service 580 may determine whether the NF 590 is authorized to receive the set of RAN configurations (e.g., based on the NF 590 being part of the untrusted domain). Accordingly, at 525, the subscription service 580 may output a subscription response message indicating the set of RAN configurations authorized for exposure to the network exposure service 585, the NF 590, or both. Additionally, or alternatively, the subscription response may also include a set of non-allowed RAN configurations.

At 530, the NF 590, the network exposure service 585, or both may output a RAN configuration subscription message to the RAN exposure service 510 (e.g., subscribes to the RAN 505 via the RAN exposure service 510). In some examples, the RAN configuration subscription message may include the set of RAN configurations authorized for exposure requested by the network exposure service 585, the NF 590, or both.

At 535, the RAN exposure service 510 may output a subscription message (e.g., UE RRC connected subscription) to the AMS 595. The subscription message may request notification of when the UE 115-d establishes a connection (e.g., to get notified when the UE 115-d or a list of UEs enters a RRC connected state). In such examples, at 540, the AMS 595 may output an indication of a UE connected state (e.g., when the UE 115-d establishes a connection). In some examples, the indication may include an indication of a RAN ID associated with a RAN connected to the UE 115-d (e.g., the RAN 505). For example, based on the UE 115-d connecting, the AMS 595 may notify the RAN exposure service 510 with the RAN ID.

At 545, based on receiving the indication of the RAN ID (e.g., and the indication of the UE RRC connected state), the RAN exposure service 510 may output a RAN configuration notification subscription message to the RAN 505 (e.g., the RAN exposure service 510 may subscribe to the RAN 505). In some examples, the RAN configuration notification subscription message may include an indication of the RAN configurations authorized for exposure (e.g., the RAN configurations authorized for exposure indicated by the subscription service 580).

At 550, the RAN 505 may output an indication of a set of RAN configurations authorized for exposure (e.g., a RAN configuration notification subscription response message) based at least in part on receiving the RAN configuration subscription. In some examples, the set of RAN configurations authorized for exposure may be a set of RAN configurations supported by the RAN 505, and may be a subset of the RAN configurations allowed for the UE 115-d to access (e.g., based on the RAN 505 supporting the configurations). Additionally, or alternatively, the indication may include an indication of one or more RAN events, RAN status exposures, or both.

At 555, the RAN exposure service 510 may output (e.g., forward), an indication of the set of RAN configurations authorized for exposure (e.g., the RAN configuration notification subscription response message) to the network exposure service 585, the NF 590, or both based on receiving the indication of the set of RAN configurations authorized for exposure.

In some implementations, at least one RAN configuration of the set of RAN configurations authorized for exposure may satisfy a reporting condition (e.g., meeting the requested RAN configuration, RAN event, or RAN status exposure). For example, one RAN configuration of the set of RAN configurations authorized for exposure or a RAN status may change, or a RAN event may occur. In such examples, at 560, the RAN 505 may output, and the RAN exposure service 510 may receive, an indication (e.g., a report) indicating the set of RAN configurations based on at least one of the RAN configurations satisfying the reporting condition. In such examples, the indication may include a state of each of the RAN configurations of the set of RAN configurations authorized for exposure, or may include an indication of one or more of the RAN configurations for which the reporting conditions were satisfied..

At 565, based on receiving the indication, the RAN exposure service 510 may output (e.g., forward) the indication to the network exposure service 585, the NF 590, or both. In such examples, the indication may include a state of each of the RAN configurations of the set of RAN configurations authorized for exposure, or may include an indication of one or more of the RAN configurations for which the reporting conditions were satisfied.

At 570, based on receiving the indication from the RAN exposure service 510, the NF 590 may output an indication of the set of RAN configurations to the UE 115-d (e.g., via an over-the-top (OTT) indication). In such examples, the UE 115-d may indirectly receive the indication of the RAN configurations (e.g., indirectly from the RAN 505) via the network exposure service 585, the NF 590, or both.

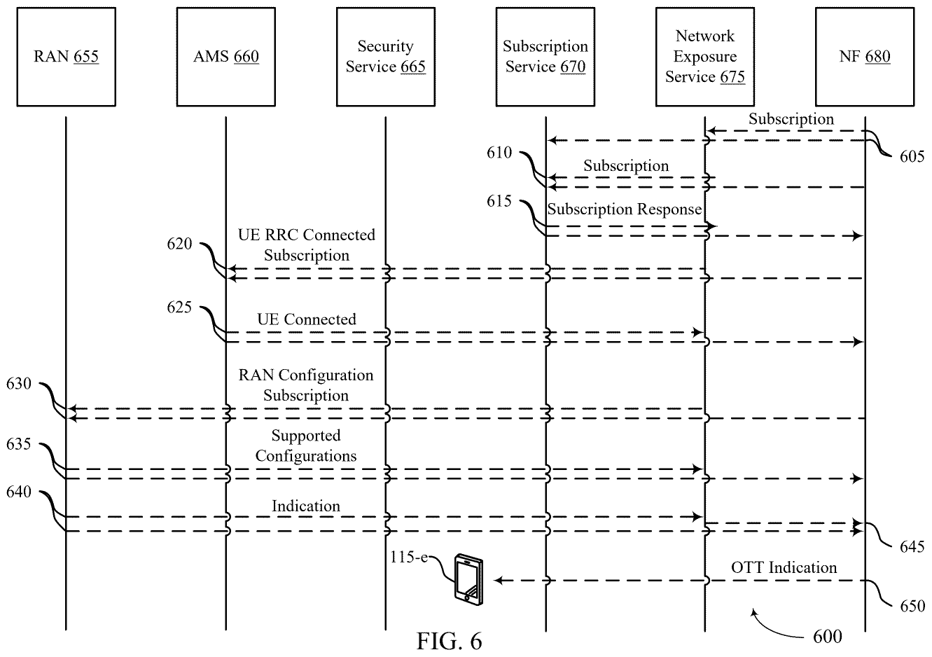

FIG. 6 shows an example of a process flow 600 that supports methods for radio access network configuration exposure and subscription in accordance with one or more aspects of the present disclosure. In some implementations, the process flow 600 may implement or be implemented by aspects of the wireless communications system 100 and the wireless communications system 200. For example, the process flow 600 may include a UE 115-e, which may be an example of the UE 115. The process flow 600 may further include a RAN 655, an AMS 660, a security service 665, a subscription service 670, a network exposure service 675, and a NF 680. Techniques described herein with reference to FIG. 6 may enable the exposure of RAN configurations directly (e.g., without a RAN exposure service).

At 605, the NF 680 may output a subscription message to the network exposure service 675, the subscription service 670 or both. For example, in some implementations, the NF 680 may output the subscription message to the subscription service 490 directly based on the NF 680 being part of a trusted domain. In some other examples described herein, the functions performed by the NF 680 may be performed by the network exposure service 675 (e.g., instead of the NF 680) based on the NF 680 being part of an untrusted domain (e.g., communications and functions may be operated by the trusted network exposure service 675 instead). For example, when the NF 680 is part of an untrusted domain, the NF 680 may output the subscription message to the network exposure service 675, and the network exposure service 675 may correspondingly forward the subscription message to one or more other network services.

At 610, the NF 680, the network exposure service 675 (e.g., based on receiving the subscription message of 515 from the NF 680), or both may output a subscription request message. For example, the subscription request message may include an indication of a set of RAN configurations requested by the NF 680 (e.g., requested by the UE 115-e via the NF 680, or by the NF 680 for the UE 115-e). In some examples, the subscription service 670 may determine a set of allowed (e.g., supported) RAN configurations (e.g., the subscription service 670 may determine which RAN configurations of the set of RAN configurations the UE 115-e may be allowed to access). Additionally, or alternatively, the subscription service 670 may determine whether the NF 680 is authorized to receive the set of RAN configurations (e.g., based on the NF 680 being part of the untrusted domain). Accordingly, at 615, the subscription service 670 may output a subscription response message indicating the set of RAN configurations authorized for exposure to the network exposure service 675, the NF 680, or both. Additionally, or alternatively, the subscription response may also include a set of non-allowed RAN configurations.

At 620, the network exposure service 675, the NF 680, or both (e.g., based on the NF 680 being part of a trusted domain) may output a subscription message (e.g., UE RRC connected subscription) to the AMS 660. The subscription message may request notification of when the UE 115-e establishes a connection (e.g., to get notified when the UE 115-e or a list of UEs enters a RRC connected state). In such examples, at 625, the AMS 660 may output an indication of a UE connected state (e.g., when the UE 115-e establishes a connection) to the network exposure service 675, the NF 680, or both. In some examples, the indication may include an indication of a RAN ID associated with a RAN connected to the UE 115-e (e.g., the RAN 655). For example, based on the UE 115-e connecting, the AMS 660 may notify the network exposure service 675, the NF 680, or both with the RAN ID.

At 630, based on receiving the indication of the RAN ID (e.g., and the indication of the UE RRC connected state), the network exposure service 675, the NF 680, or both may output a RAN configuration notification subscription message to the RAN 655 (e.g., the network exposure service 675, the NF 680, or both may subscribe to the RAN 655 for RAN configuration notifications). In some examples, the RAN configuration subscription message may include an indication of the allowable RAN configurations (e.g., the allowable RAN configurations indicated by the subscription service 670).

At 635, the RAN 655 may output an indication of a set of RAN configurations authorized for exposure (e.g., a RAN configuration notification subscription response message) to the network exposure service 675, the NF 680, or both based at least in part on receiving the RAN configuration subscription. In some examples, the set of RAN configurations authorized for exposure may be a set of RAN configurations supported by the RAN 655, and may be a subset of the RAN configurations allowed for the UE 115-e to access (e.g., based on the RAN 655 supporting the configurations). Additionally, or alternatively, the indication may include an indication of one or more RAN events, RAN status exposures, or both.

In some implementations, at least one RAN configuration of the set of RAN configurations authorized for exposure may satisfy a reporting condition (e.g., meeting the requested RAN configuration, RAN event, or RAN status exposure). For example, one RAN configuration of the set of RAN configurations authorized for exposure or a RAN status may change, or a RAN event may occur. In such examples, at 640, the RAN 655 may output an indication (e.g., a report) including the set of RAN configurations to the network exposure service 675, the NF 680, or both based on at least one RAN configuration of the set of RAN configurations satisfying the reporting condition. In such examples, the indication may include a state of each of the RAN configurations of the set of RAN configurations authorized for exposure, or may include an indication of one or more of the RAN configurations for which the reporting conditions were satisfied.

At 645, based on receiving the indication, the network exposure service 675 may output (e.g., forward) the indication to the NF 680. In some examples, the network exposure service 675 may forward the indication to the NF 680 based on the NF 680 being part of the untrusted domain. In such examples, the indication may include a state of each of the RAN configurations of the set of RAN configurations authorized for exposure, or may include an indication of one or more of the RAN configurations for which the reporting conditions were satisfied.

At 650, based on receiving the indication from the RAN 655, the network exposure service 675, or both, the NF 680 may output an indication of the set of RAN configurations to the UE 115-e (e.g., via an OTT indication). In such examples, the UE 115-e may indirectly receive the indication of the RAN configurations (e.g., indirectly from the RAN 655) via the network exposure service 675, the NF 680, or both.

FIG. 7 shows an example of a process flow 700 that supports methods for radio access network configuration exposure and subscription in accordance with one or more aspects of the present disclosure. In some implementations, the process flow 700 may implement or be implemented by aspects of the wireless communications system 100 and the wireless communications system 200. For example, the process flow 700 may include a UE 115-f, which may be and example of the UE 115. Additionally, or alternatively, the process flow 700 may include a RAN 760, an AMS 765, a RAN exposure service 770, and a subscription service 775.

At 705, the UE 115-f may output a RAN configuration notification request message to the AMS 765. In some examples, the RAN configuration notification request message may include an indication of a set of RAN configurations for which the UE 115-b is requesting notifications (e.g., interested RAN configurations for the UE 115-f).

At 710, the AMS 765 may select (e.g., identify or determine, among other examples) a RAN exposure service. In such examples, the selected RAN exposure service may be used by the AMS 765 to expose RAN configurations to the UE 115-f or other services.

At 715, the AMS 765 may correspondingly output a RAN configuration exposure request message (e.g., RAN_Configuration_Exposure_Request) to the selected RAN exposure service 770 (e.g., forwarding the RAN configuration notification request message).

At 720, the RAN exposure service 770 may output a UE subscription request message (e.g., for the UE 115-f) to the subscription service 775 (e.g., forwarding the RAN configuration notification request message) based on receiving the RAN configuration exposure request message.

At 725, the subscription service 775 may output a UE subscription response message indicating a set of allowable RAN configurations (e.g., the subscription service 775 may determine which RAN configurations of the set of RAN configurations the UE 115-f may be allowed to access). Additionally, or alternatively, the UE subscription response message may also include a set of non-allowed RAN configurations.

At 730, the RAN exposure service 770 may, based on receiving the UE subscription response message and the set of allowable RAN configurations, output a RAN configuration activation request message to the AMS 765 (e.g., subscribing to the RAN 760 via the AMS 765 for RAN configuration notifications). At 735, the AMS 765 may correspondingly output (e.g., forward) the RAN configuration activation request to the RAN 760.

At 740, the RAN 760 may output (e.g., based on receiving the RAN configuration activation request message) a RAN configuration activation response message to the AMS 765. In some implementations, the RAN configuration activation response message may include an indication of a set of supported (e.g., supported or enabled by the RAN 760) RAN configurations. In some examples, the set of RAN configurations authorized for exposure may be a subset or a list including the set of allowable RAN configurations. At 745, the AMS 840 may correspondingly output (e.g., forward) the RAN configuration activation response to the RAN exposure service 770.

At 750, the RAN exposure service 770 may output a RAN configuration exposure response message (e.g., RAN_Configuration_Exposure_Response) to the AMS 765.

At 755, the UE 115-f may receive an indication including the set of RAN configurations authorized for exposure, or indicating one or more of the RAN configurations for which the reporting conditions were satisfied. In some examples, the UE 115-f may receive the indication based on at least one RAN configuration of the set of RAN configurations authorized for exposure satisfying a reporting condition. In some implementations, the UE 115-f may receive the indication from the AMS 765, the RAN exposure service 770, or both. Additionally, or alternatively, the UE 115-f may receive the indication via one or more signaling protocols, including control plane signaling (e.g., from the AMS 765), NAS protocol signaling, user plane signaling (e.g., from the RAN exposure service 770), or other signaling types.

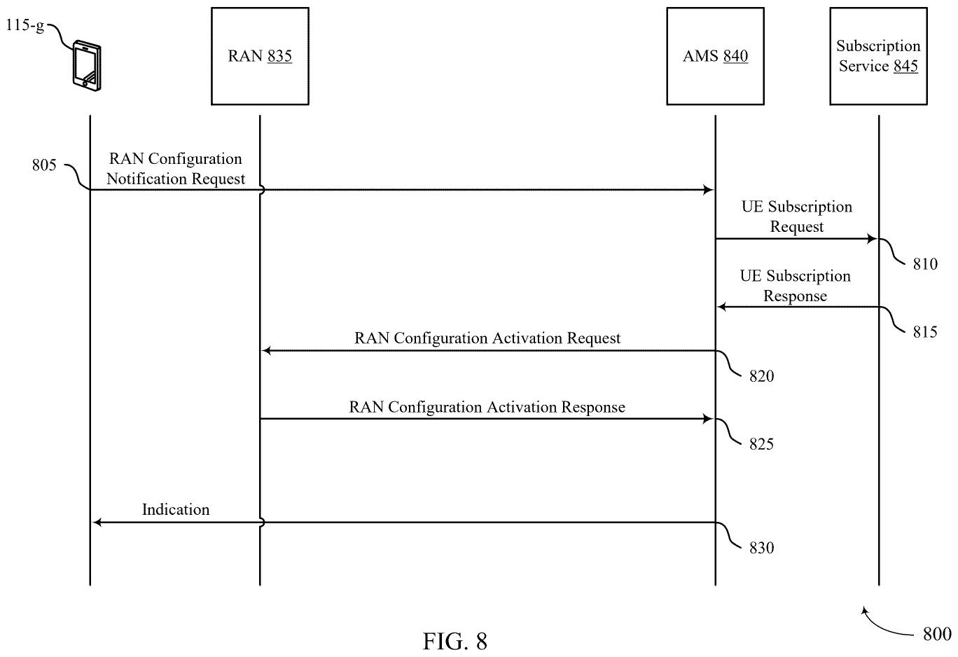

FIG. 8 shows an example of a process flow 800 that supports methods for radio access network configuration exposure and subscription in accordance with one or more aspects of the present disclosure. In some implementations, the process flow 800 may implement or be implemented by aspects of the wireless communications system 100 and the wireless communications system 200. For example, the process flow 800 may include a UE 115-g, which may be an example of the UE 115. Additionally, or alternatively, the process flow 800 may further include a RAN 835, an AMS 840, and a subscription service 845. Techniques described herein with reference to FIG. 8 may enable the exposure of RAN configurations directly (e.g., without a RAN exposure service).

At 805, the UE 115-g may transmit a RAN configuration notification request message to the AMS 840. In some examples, the RAN configuration notification request message may include an indication of a set of RAN configurations for which the UE 115-b is requesting notifications (e.g., interested RAN configurations for the UE 115-g). At 810, the AMS 840 may correspondingly output a UE subscription request message (e.g., for the UE 115-g) to the subscription service 845 (e.g., forwarding the RAN configuration notification request message).

At 815, the subscription service 845 may output a UE subscription response message indicating a set of allowable RAN configurations (e.g., the subscription service 845 may determine which RAN configurations of the set of RAN configurations the UE 115-g may be allowed to access). Additionally, or alternatively, the UE subscription response message may also include a set of non-allowed RAN configurations.

At 820, the AMS 840 may output a RAN configuration notification activation request message to the RAN 835 (e.g., subscribing to the RAN 835 for RAN configuration notifications).

At 825, the RAN 835 may output (e.g., based on receiving the RAN configuration activation request message) a RAN configuration notification activation response message to the AMS 840. In some implementations, the RAN configuration notification activation response message may include an indication of a set of supported (e.g., supported or enabled by the RAN 835) RAN configurations. In some examples, the set of RAN configurations authorized for exposure may be a subset or a list including the set of allowable RAN configurations.

At 830, the AMS 840 may output, and the UE 115-g may receive, an indication (e.g., a report) including the set of RAN configurations authorized for exposure (e.g., RAN configuration states), or indicating one or more of the RAN configurations for which the reporting conditions were satisfied. In some examples, the AMS 840 may output the indication based on at least one RAN configuration of the set of RAN configurations authorized for exposure satisfying a reporting condition. In some implementations, the AMS 840 may output the indication via a downlink information transfer process. Additionally, or alternatively, UE 115-g may receive the set of RAN configurations authorized for exposure via one or more additional protocols (e.g., via enhanced N2 interface application protocol (NG-AP) signaling, downlink NAS signaling, or both).

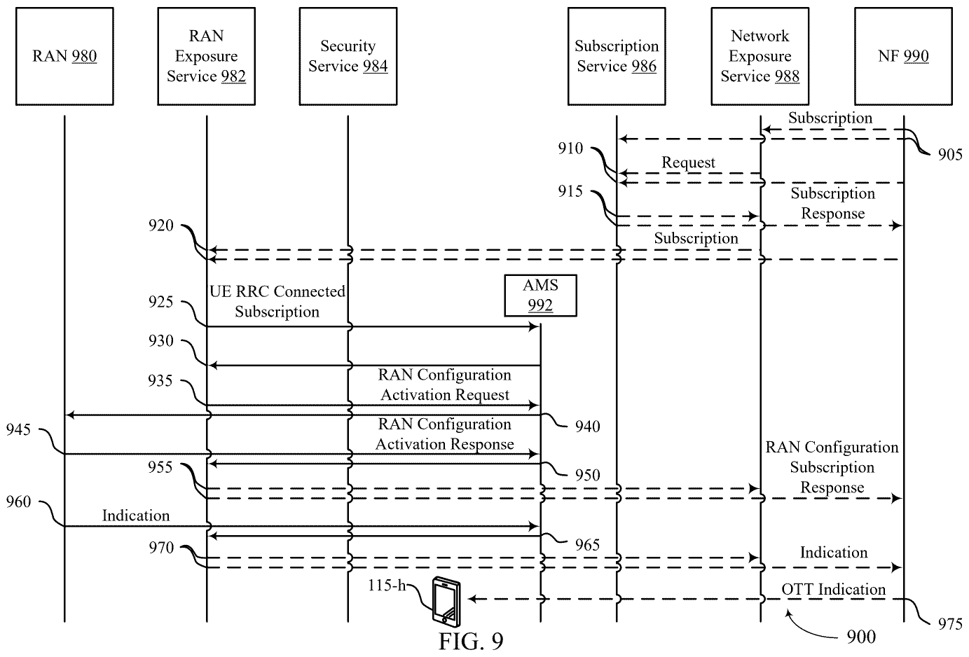

FIG. 9 shows an example of a process flow 900 that supports methods for radio access network configuration exposure and subscription in accordance with one or more aspects of the present disclosure. In some implementations, the process flow 900 may implement or be implemented by aspects of the wireless communications system 100 and the wireless communications system 200. For example, the process flow 900 may include a UE 115-h, which may be an example of the UE 115. Additionally, or alternatively, the process flow 900 may include a RAN 980, a RAN exposure service 982, a security service 984,, a subscription service 986, a network exposure service 988, a NF 990, and an AMS 992.

At 905, the NF 990 may output a subscription message to the network exposure service 988, the subscription service 986 or both. For example, in some implementations, the NF 990 may output the subscription message to the subscription service 986 directly based on the NF 990 being part of a trusted domain. In some other examples described herein, the functions performed by the NF 990 may be performed by the network exposure service 988 (e.g., instead of the NF 990) based on the NF 990 being part of an untrusted domain (e.g., communications and functions may be operated by the trusted network exposure service 988 instead). For example, when the NF 990 is part of an untrusted domain, the NF 990 may output the subscription message to the network exposure service 988, and the network exposure service 988 may correspondingly forward the subscription message to one or more other network services.

At 910, the NF 990, the network exposure service 988 (e.g., based on receiving the subscription message of 515 from the NF 990 and on the NF 990 being part of an untrusted domain), or both may output a subscription request message to the subscription service 986. For example, the subscription request message may include an indication of a set of RAN configurations requested by the NF 990 (e.g., requested by the UE 115-h via the NF 990, or by the NF 990 for the UE 115-h). In some examples, the subscription service 986 may determine a set of allowed (e.g., supported) RAN configurations (e.g., the subscription service 986 may determine which RAN configurations of the set of RAN configurations the UE 115-h may be allowed to access). Additionally, or alternatively, the subscription service 986 may determine whether the NF 990 is authorized to receive the set of RAN configurations (e.g., based on the NF 990 being part of the untrusted domain). Accordingly, at 915, the subscription service 986 may output a subscription response message indicating the set of RAN configurations authorized for exposure to the network exposure service 988, the NF 990, or both. Additionally, or alternatively, the subscription response may also include a set of non-allowed RAN configurations.

At 920, the NF 990, the network exposure service 988, or both may output a RAN configuration subscription message to the RAN exposure service 982 (e.g., subscribes to the RAN 980 via the RAN exposure service 982). In some examples, the RAN configuration subscription message may include the set of RAN configurations authorized for exposure requested by the network exposure service 988, the NF 990, or both.

At 925, the RAN exposure service 982 may output a subscription message (e.g., UE RRC connected subscription) to the AMS 992. The subscription message may request notification of when the UE 115-h establishes a connection (e.g., to get notified when the UE 115-h or a list of UEs enters a RRC connected state). In such examples, at 930, the AMS 992 may output an indication of a UE connected state (e.g., when the UE 115-h establishes a connection) to the RAN exposure service 982. In some examples, the indication may include an indication of a RAN ID associated with a RAN connected to the UE 115-h (e.g., the RAN 980). For example, based on the UE 115-h connecting, the AMS 992 may notify the RAN exposure service 982 with the RAN ID.

At 935, based on receiving the indication of the RAN ID (e.g., and the indication of the UE RRC connected state), the RAN exposure service 982 may output a RAN configuration notification activation request message to the AMS 992 (e.g., the RAN exposure service 982 may subscribe to the AMS 992 for RAN configuration notifications). In some examples, the RAN configuration notification activation request message may include an indication of the allowable RAN configurations (e.g., the allowable RAN configurations indicated by the subscription service 986). At 940, the AMS 992 may correspondingly output (e.g., forward) the RAN configuration activation request message to the RAN 980.

At 945, the RAN 980 may output a RAN configuration notification activation response message including an indication of a set of RAN configurations authorized for exposure to the AMS 992 based at least in part on receiving the RAN configuration notification activation request. In some examples, the set of RAN configurations authorized for exposure may be a set of RAN configurations supported by the RAN 980, and may be a subset of the RAN configurations allowed for the UE 115-h to access (e.g., based on the RAN 980 supporting the configurations). Additionally, or alternatively, the indication may include an indication of one or more RAN events, RAN status exposures, or both. At 950, the AMS 992 may correspondingly output (e.g., forward) the RAN configuration activation response (e.g., a RAN configuration subscription response) to the RAN exposure service 982.

At 955, the RAN exposure service 982 may output (e.g., forward) the RAN configuration activation response to the network exposure service 988, the NF 990, or both. In some examples, the RAN configuration subscription response may include the set of allowable and RAN configurations authorized for exposure, the set of non-allowable or non-RAN configurations authorized for exposure, or any combination thereof.

In some implementations, at least one RAN configuration of the set of RAN configurations authorized for exposure may satisfy a reporting condition (e.g., meeting the requested RAN configuration, RAN event, or RAN status exposure). For example, one RAN configuration of the set of RAN configurations authorized for exposure or a RAN status may change, or a RAN event may occur. In such examples, at 960, the RAN 980 may output an indication (e.g., a report) indicating the set of RAN configurations to the AMS 992 based on at least one of the RAN configurations satisfying the reporting condition. In such examples, the indication may include a state of each of the RAN configurations of the set of RAN configurations authorized for exposure, or may include an indication of one or more of the RAN configurations for which the reporting conditions were satisfied. At 965, the AMS 992 may correspondingly output (e.g., forward) the indication to the RAN exposure service 982.

At 970, based on receiving the indication, the RAN exposure service 982 may output (e.g., forward) the indication to the network exposure service 988, the NF 990, or both. In such examples, the indication may include a state of each of the RAN configurations of the set of RAN configurations authorized for exposure, or may include an indication of one or more of the RAN configurations for which the reporting conditions were satisfied.

At 975, based on receiving the indication from the RAN 980, the network exposure service 988, or both, the NF 990 may output an indication of the set of RAN configurations to the UE 115-h (e.g., via an OTT indication). In such examples, the UE 115-h may indirectly receive the indication of the RAN configurations (e.g., indirectly from the RAN 980) via the network exposure service 988, the NF 990, or both.

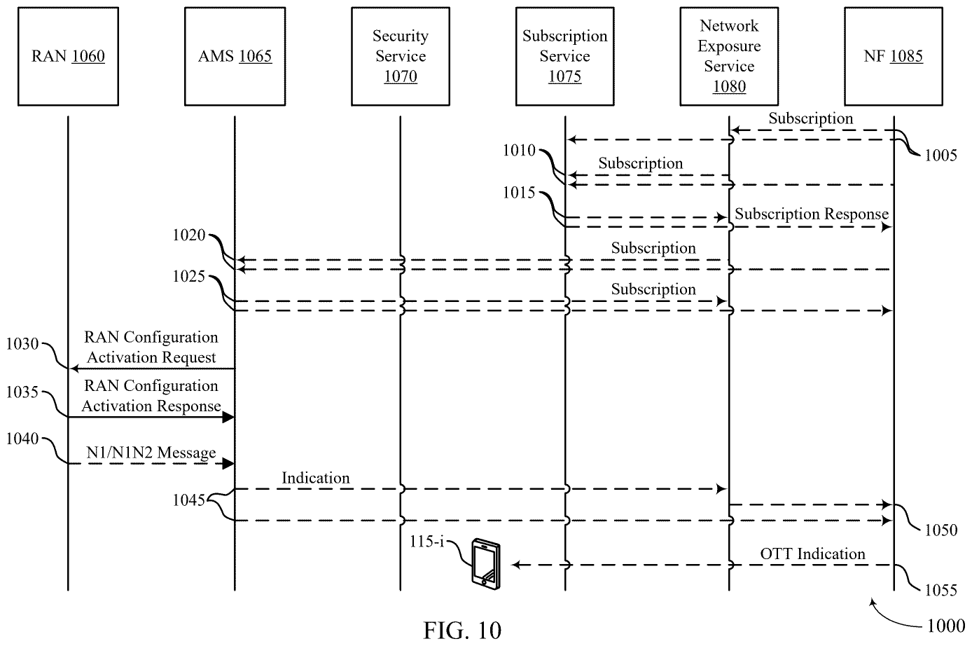

FIG. 10 shows an example of a process flow 1000 that supports methods for radio access network configuration exposure and subscription in accordance with one or more aspects of the present disclosure. In some implementations, the process flow 1000 may implement or be implemented by aspects of the wireless communications system 100 and the wireless communications system 200. For example, the process flow 1000 may include a UE 115-i, which may be an example of the UE 115. Additionally, or alternatively, the process flow 1000 may include a RAN 1060, an AMS 1065, a security service 1070, a subscription service 1075, a network exposure service 1080, and a NF 1085. Techniques described herein with reference to FIG. 6 may enable the exposure of RAN configurations directly (e.g., without a RAN exposure service).

At 1005, the NF 1085 may output a subscription message to the network exposure service 1080, the subscription service 1075 or both. For example, in some implementations, the NF 1085 may output the subscription message to the subscription service 1075 directly based on the NF 1085 being part of a trusted domain. In some other examples described herein, the functions performed by the NF 1085 may be performed by the network exposure service 1080 (e.g., instead of the NF 1085) based on the NF 1085 being part of an untrusted domain (e.g., communications and functions may be operated by the trusted network exposure service 1080 instead). For example, when the NF 1085 is part of an untrusted domain, the NF 1085 may output the subscription message to the network exposure service 1080, and the network exposure service 1080 may correspondingly forward the subscription message to one or more other network services.

At 1010, the NF 1085, the network exposure service 1080 (e.g., based on receiving the subscription message of 515 from the NF 1085 and on the NF 1085 being part of an untrusted domain), or both may output a subscription request message to the subscription service 1075. For example, the subscription request message may include an indication of a set of RAN configurations requested by the NF 1085 (e.g., requested by the UE 115-d via the NF 1085, or by the NF 1085 for the UE 115-d). In some examples, the subscription service 1075 may determine a set of allowed (e.g., supported) RAN configurations (e.g., the subscription service 1075 may determine which RAN configurations of the set of RAN configurations the UE 115-d may be allowed to access). Additionally, or alternatively, the subscription service 1075 may determine whether the NF 1085 is authorized to receive the set of RAN configurations (e.g., based on the NF 1085 being part of the untrusted domain). Accordingly, at 1015, the subscription service 1075 may output a subscription response message indicating the set of RAN configurations authorized for exposure to the network exposure service 1080, the NF 1085, or both. Additionally, or alternatively, the subscription response may also include a set of non-allowed RAN configurations.

At 1020, the NF 1085, the network exposure service 1080, or both may output a RAN configuration notification subscription message to the AMS 1065 (e.g., subscribes to the RAN 1060 via the AMS 1065). In some examples, the RAN configuration notification subscription message may include the set of RAN configurations authorized for exposure requested by the network exposure service 1080, the NF 1085, or both (e.g., requested by the UE 115-i, one or more services, or both via the network exposure service 1080, the NF 1085, or both).

At 1025, the AMS 1065 may output a RAN configuration notification subscription response message including an indication of a set of RAN configurations authorized for exposure to the network exposure service 1080, the NF 1085, or both based at least in part on receiving the RAN configuration notification subscription request message. In some examples, the set of RAN configurations authorized for exposure may be a set of RAN configurations supported by the RAN 1060, and may be a subset of the RAN configurations allowed for the UE 115-i to access (e.g., based on the RAN 1060 supporting the configurations). Additionally, or alternatively, the message may include an indication of one or more RAN events, RAN status exposures, or both.

At 1030, the AMS 1065 may output a RAN configuration notification activation request message to the RAN 1060 (e.g., the AMS 1065 may subscribe to the RAN 1060 for RAN configuration notifications). In some examples, the RAN configuration notification subscription message may include an indication of the allowable RAN configurations (e.g., the allowable RAN configurations indicated by the subscription service 1075).

At 1035, the RAN 1060 may output a RAN configuration notification activation response message including an indication of a set of RAN configurations authorized for exposure to the AMS 1065 based at least in part on receiving the RAN configuration notification activation request. In some examples, the set of RAN configurations authorized for exposure may be a set of RAN configurations supported by the RAN 1060, and may be a subset of the RAN configurations allowed for the UE 115-i to access (e.g., based on the RAN 1060 supporting the configurations). Additionally, or alternatively, the indication may include an indication of one or more RAN events, RAN status exposures, or both.

In some implementations, at least one RAN configuration of the set of RAN configurations authorized for exposure may satisfy a reporting condition (e.g., meeting the requested RAN configuration, RAN event, or RAN status exposure). For example, one RAN configuration of the set of RAN configurations authorized for exposure or a RAN status may change, or a RAN event may occur. In such examples, the RAN 1060 may output an indication (e.g., a report) indicating the set of RAN configurations to the AMS 1065 based on at least one of the RAN configurations satisfying the reporting condition. In such examples, the indication may include a state of each of the RAN configurations of the set of RAN configurations authorized for exposure, or may include an indication of one or more of the RAN configurations for which the reporting conditions were satisfied.

Additionally, or alternatively, at 1040, the RAN 1060 may output a RAN configuration notification response message indicating the set of RAN configurations to the AMS 1065 via one or more application layer protocol services (e.g., N2 services or N1N2 services) based on at least one of the RAN configurations satisfying the reporting condition.

At 1045, based on receiving the indication, the AMS 1065 may output (e.g., forward) the indication to the network exposure service 1080, the NF 1085, or both. In such examples, the indication may include a state of each of the RAN configurations of the set of RAN configurations authorized for exposure, or may include an indication of one or more of the RAN configurations for which the reporting conditions were satisfied. Additionally, or alternatively, at 1050, the network exposure service 1080 may output (e.g., forward) the indication to the NF 1085 based on receiving the indication from the AMS 1065.

At 1055, based on receiving the indication from the RAN 1060, the network exposure service 1080, or both, the NF 1085 may output an indication of the set of RAN configurations to the UE 115-i (e.g., via an OTT indication). In such examples, the UE 115-i may indirectly receive the indication of the RAN configurations (e.g., indirectly from the RAN 1060) via the network exposure service 1080, the NF 1085, or both.

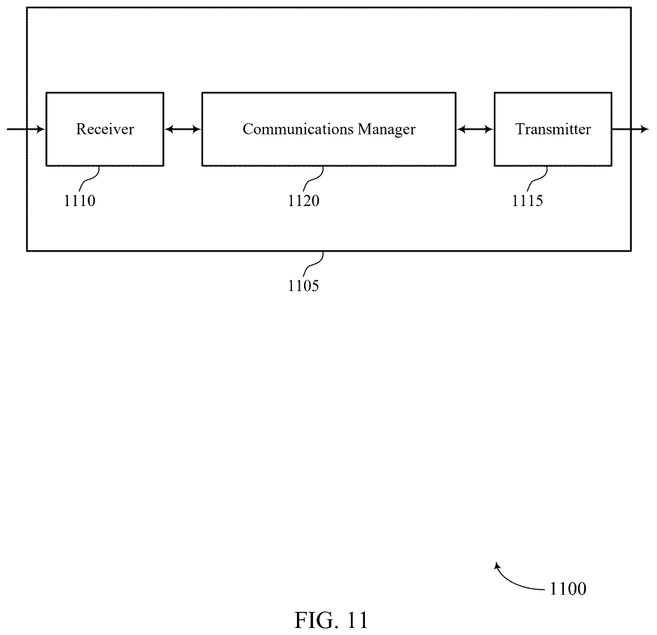

FIG. 11 shows a block diagram 1100 of a device 1105 that supports methods for radio access network configuration exposure and subscription in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of methods for radio access network configuration exposure and subscription as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for obtaining a first request message requesting information associated with one or more RAN configuration states of a RAN. The communications manager 1120 is capable of, configured to, or operable to support a means for outputting, to at least a second device based on obtaining the first request message, a first response message indicating that the information associated with the one or more RAN configuration states of the RAN is supported. The communications manager 1120 is capable of, configured to, or operable to support a means for outputting based on outputting the first response message, a notification message or indication including a report of the one or more RAN configuration states.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing and more efficient utilization of communication resources, among other examples.

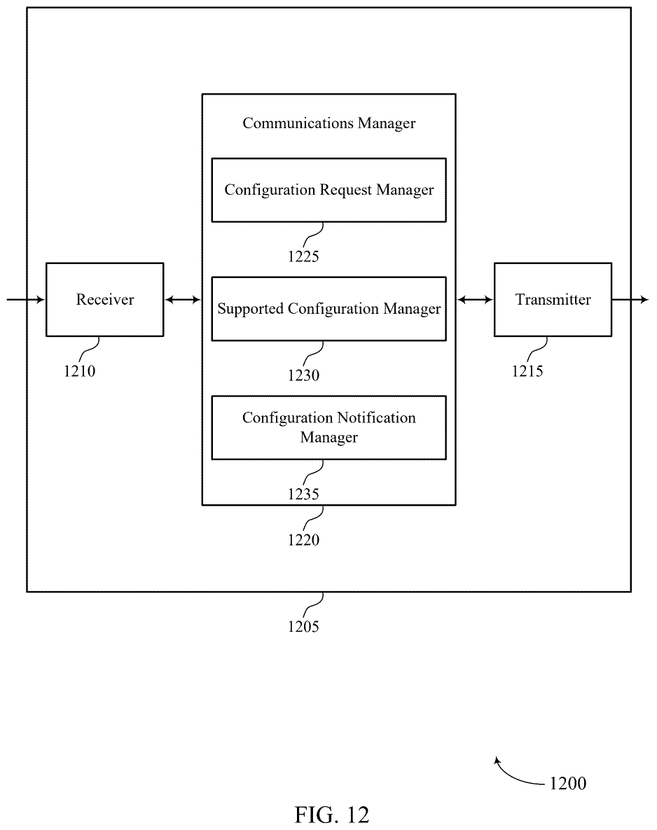

FIG. 12 shows a block diagram 1200 of a device 1205 that supports methods for radio access network configuration exposure and subscription in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of methods for radio access network configuration exposure and subscription as described herein. For example, the communications manager 1220 may include a configuration request manager 1225, a supported configuration manager 1230, a configuration notification manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The configuration request manager 1225 is capable of, configured to, or operable to support a means for obtaining a first request message requesting information associated with one or more RAN configuration states of a RAN. The supported configuration manager 1230 is capable of, configured to, or operable to support a means for outputting, to at least a second device based on obtaining the first request message, a first response message indicating that the information associated with the one or more RAN configuration states of the RAN is supported. The configuration notification manager 1235 is capable of, configured to, or operable to support a means for outputting based on outputting the first response message, a notification message or indication including a report of the one or more RAN configuration states.

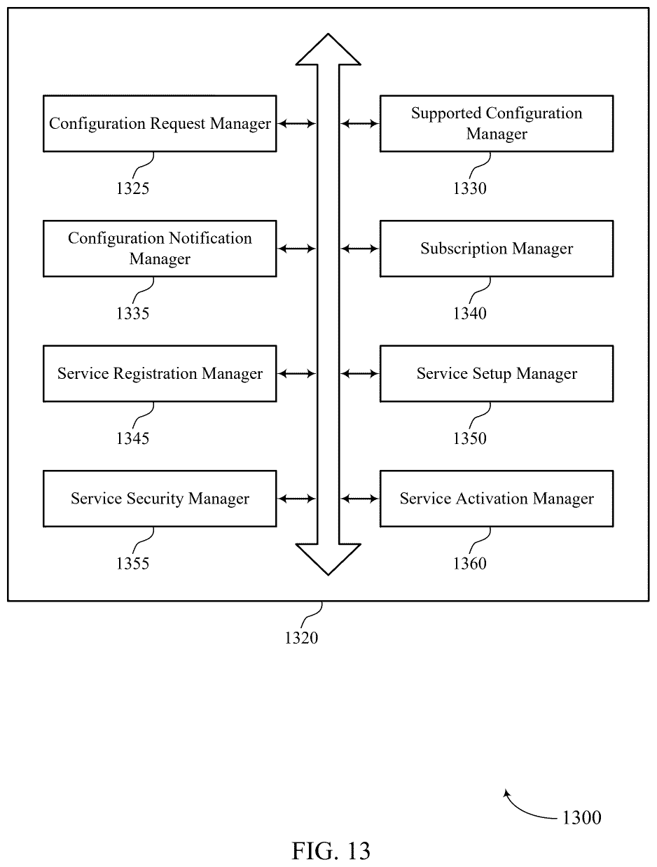

FIG. 13 shows a block diagram 1300 of a communications manager 1320 that supports methods for radio access network configuration exposure and subscription in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of methods for radio access network configuration exposure and subscription as described herein. For example, the communications manager 1320 may include a configuration request manager 1325, a supported configuration manager 1330, a configuration notification manager 1335, a subscription manager 1340, a service registration manager 1345, a service setup manager 1350, a service security manager 1355, a service activation manager 1360, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The configuration request manager 1325 is capable of, configured to, or operable to support a means for obtaining a first request message requesting information associated with one or more RAN configuration states of a RAN. The supported configuration manager 1330 is capable of, configured to, or operable to support a means for outputting, to at least a second device based on obtaining the first request message, a first response message indicating that the information associated with the one or more RAN configuration states of the RAN is supported. The configuration notification manager 1335 is capable of, configured to, or operable to support a means for outputting based on outputting the first response message, a notification message or indication including a report of the one or more RAN configuration states.

In some examples, the subscription manager 1340 is capable of, configured to, or operable to support a means for outputting, to a second network entity including a subscription service based on obtaining the first request message from a UE, a subscription request message including a first identifier associated with the UE, and an indication that notification of the one or more RAN configuration states is requested by the UE. In some examples, the subscription manager 1340 is capable of, configured to, or operable to support a means for obtaining, from the second network entity based on outputting the subscription request message, a subscription response message including the first identifier and including subscription permission information corresponding to at least one of the one or more RAN configuration states, where outputting the first response message is based on the subscription response message.

In some examples, the service registration manager 1345 is capable of, configured to, or operable to support a means for obtaining, from the second device including a UE, a registration message including a request to establish service for the UE. In some examples, the service setup manager 1350 is capable of, configured to, or operable to support a means for outputting, based on obtaining the registration message, a security setup request message to a third network entity including a security service. In some examples, the service security manager 1355 is capable of, configured to, or operable to support a means for obtaining, from the third network entity based on outputting the security setup request message, security context information. In some examples, the service security manager 1355 is capable of, configured to, or operable to support a means for outputting the security context information to a UE, where obtaining the first request message is based on outputting the security context information.

In some examples, the service activation manager 1360 is capable of, configured to, or operable to support a means for outputting, to the RAN based on obtaining the subscription response message, an activation request message corresponding to the one or more RAN configuration states. In some examples, the service activation manager 1360 is capable of, configured to, or operable to support a means for obtaining, from the RAN based on the activation request message, an activation response message for at least one of the one or more RAN configuration states, where outputting the first response message is based on the activation response message, and where the second device includes a UE.

In some examples, the subscription manager 1340 is capable of, configured to, or operable to support a means for outputting, to a second network entity and based on obtaining the first request message, subscription information corresponding to a UE, the second network entity including an access and mobility service. In some examples, the subscription manager 1340 is capable of, configured to, or operable to support a means for obtaining, from the second network entity based on outputting the subscription information, subscription notification information corresponding to the one or more RAN configuration states and including a second identifier corresponding to the RAN.

In some examples, the configuration notification manager 1335 is capable of, configured to, or operable to support a means for outputting, to the RAN based at least in part on the second identifier, a second request message requesting the information associated with the one or more RAN configuration states of the RAN. In some examples, the supported configuration manager 1330 is capable of, configured to, or operable to support a means for obtaining, from the RAN based on outputting the second request message to at least the second device, a second response message indicating that the information associated with the one or more RAN configuration states of the RAN is supported, where the second device includes the UE, and where outputting the first response message to the UE is based on obtaining the second response message from the RAN.

In some examples, the configuration notification manager 1335 is capable of, configured to, or operable to support a means for obtaining, from the RAN based on outputting the first response message, an indication of the report of the one or more RAN configuration states, where outputting the notification message or indication is based on obtaining the indication of the report.

In some examples, the second device includes the UE. In some examples, outputting the first response message to the UE includes outputting the first response message to the UE via an application function (AF) or a network function (NF), a network exposure service, or any combination thereof. In some examples, outputting the first response message is based on obtaining a second response message from the RAN indicating that the information associated with the one or more RAN configuration states of the RAN is supported.

In some examples, the one or more RAN configuration states include a codebook index, an antenna configuration, a beam shape, one or more mobility parameters, a cell activation state, a cell deactivation state, a RAN loading configuration, or any combination thereof.

In some examples, the one or more RAN configuration states include RAN operation parameters, RAN status information, or both.

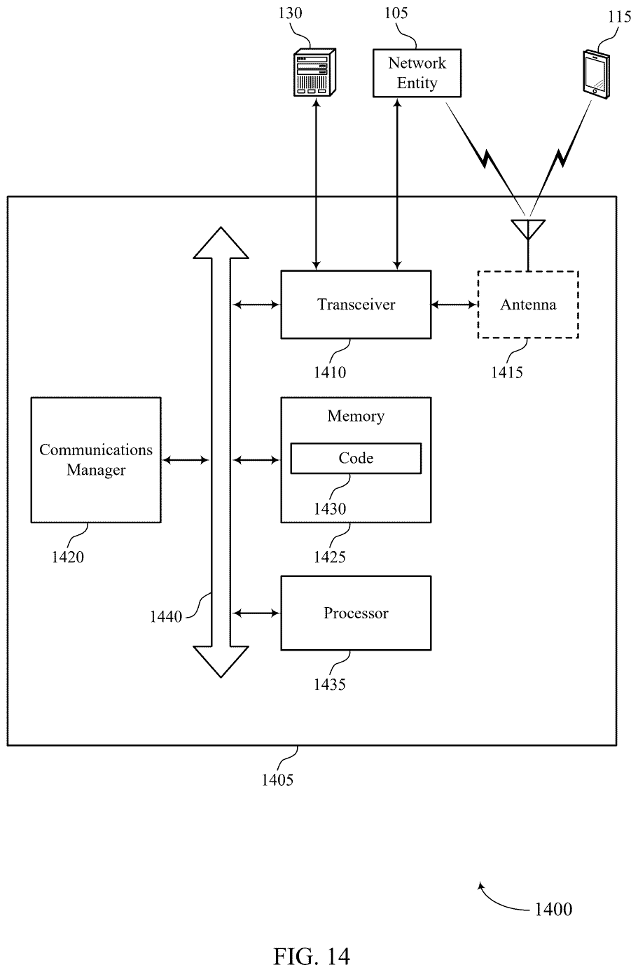

FIG. 14 shows a diagram of a system 1400 including a device 1405 that supports methods for radio access network configuration exposure and subscription in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting methods for radio access network configuration exposure and subscription). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for obtaining a first request message requesting information associated with one or more RAN configuration states of a RAN. The communications manager 1420 is capable of, configured to, or operable to support a means for outputting, to at least a second device based on obtaining the first request message, a first response message indicating that the information associated with the one or more RAN configuration states of the RAN is supported. The communications manager 1420 is capable of, configured to, or operable to support a means for outputting based on outputting the first response message, a notification message or indication including a report of the one or more RAN configuration states.

By including or configuring the communications manager 1420 in accordance with examples as described herein, the device 1405 may support techniques for reduced latency, more efficient utilization of communication resources, and improved coordination between devices, among other examples.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of methods for radio access network configuration exposure and subscription as described herein, or the at least one processor 1435 and the at least one memory 1425 may be otherwise configured to, individually or collectively, perform or support such operations.

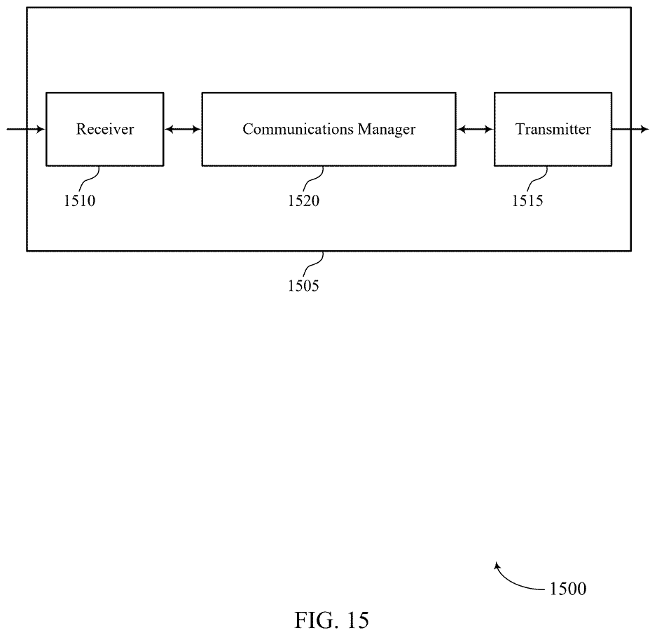

FIG. 15 shows a block diagram 1500 of a device 1505 that supports methods for radio access network configuration exposure and subscription in accordance with one or more aspects of the present disclosure. The device 1505 may be an example of aspects of a UE 115 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for receiving information such as packets, user data, control information, or any combination thereof associated with various information channels (e.g., control channels, data channels, information channels related to methods for radio access network configuration exposure and subscription). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to methods for radio access network configuration exposure and subscription). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations or components thereof may be examples of means for performing various aspects of methods for radio access network configuration exposure and subscription as described herein. For example, the communications manager 1520, the receiver 1510, the transmitter 1515, or various combinations or components thereof may be capable of performing one or more of the functions described herein.

In some examples, the communications manager 1520, the receiver 1510, the transmitter 1515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. For example, the communications manager 1520 is capable of, configured to, or operable to support a means for transmitting, to a network entity, a first request message requesting information associated with one or more RAN configuration states of a RAN. The communications manager 1520 is capable of, configured to, or operable to support a means for receiving, from the network entity based on transmitting the first request message, a first response message indicating that the information associated with the one or more RAN configuration states of the RAN is supported.

By including or configuring the communications manager 1520 in accordance with examples as described herein, the device 1505 (e.g., at least one processor controlling or otherwise coupled with the receiver 1510, the transmitter 1515, the communications manager 1520, or a combination thereof) may support techniques for reduced processing and more efficient utilization of communication resources, among other examples.

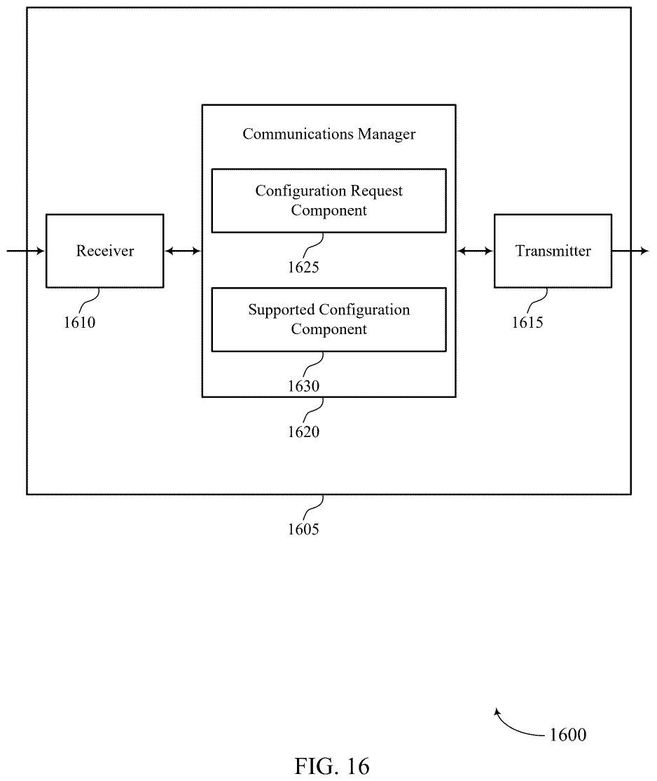

FIG. 16 shows a block diagram 1600 of a device 1605 that supports methods for radio access network configuration exposure and subscription in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for receiving information such as packets, user data, control information, or any combination thereof associated with various information channels (e.g., control channels, data channels, information channels related to methods for radio access network configuration exposure and subscription). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to methods for radio access network configuration exposure and subscription). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of methods for radio access network configuration exposure and subscription as described herein. For example, the communications manager 1620 may include a configuration request component 1625 a supported configuration component 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. The configuration request component 1625 is capable of, configured to, or operable to support a means for transmitting, to a network entity, a first request message requesting information associated with one or more RAN configuration states of a RAN. The supported configuration component 1630 is capable of, configured to, or operable to support a means for receiving, from the network entity based on transmitting the first request message, a first response message indicating that the information associated with the one or more RAN configuration states of the RAN is supported.

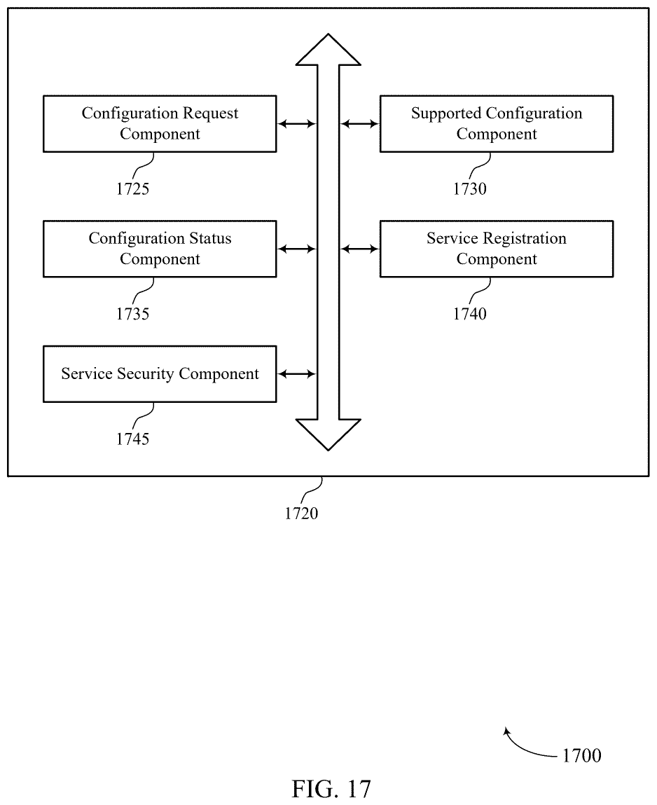

FIG. 17 shows a block diagram 1700 of a communications manager 1720 that supports methods for radio access network configuration exposure and subscription in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of methods for radio access network configuration exposure and subscription as described herein. For example, the communications manager 1720 may include a configuration request component 1725, a supported configuration component 1730, a configuration status component 1735, a service registration component 1740, a service security component 1745, or any combination thereof. Each of these components, or components or subcomponents thereof (e.g., one or more processors, one or more memories), may communicate, directly or indirectly, with one another (e.g., via one or more buses).

The communications manager 1720 may support wireless communications in accordance with examples as disclosed herein. The configuration request component 1725 is capable of, configured to, or operable to support a means for transmitting, to a network entity, a first request message requesting information associated with one or more RAN configuration states of a RAN. The supported configuration component 1730 is capable of, configured to, or operable to support a means for receiving, from the network entity based on transmitting the first request message, a first response message indicating that the information associated with the one or more RAN configuration states of the RAN is supported.

In some examples, the configuration status component 1735 is capable of, configured to, or operable to support a means for receiving, based on receiving the first response message, a notification message or indication including a report of the one or more RAN configuration states.

In some examples, the first request message requests the information associated with a set of multiple RAN configuration states of the RAN, and the first response message indicates that a subset of the set of multiple RAN configuration states is supported.

In some examples, the configuration request component 1725 is capable of, configured to, or operable to support a means for determining the one or more RAN configuration states of the RAN based on one or more conditions at the UE, where transmitting the first request message is based on the determining.

In some examples, the one or more RAN configuration states include a codebook index, an antenna configuration, a beam shape, one or more mobility parameters, a cell activation state, a cell deactivation state, a RAN loading configuration, or any combination thereof.

In some examples, the network entity includes a RAN, a RAN exposure service, a network exposure service, a subscription service, an access and mobility service, or any combination thereof.

In some examples, the service registration component 1740 is capable of, configured to, or operable to support a means for transmitting a registration message including a request to establish service for the UE. In some examples, the service security component 1745 is capable of, configured to, or operable to support a means for receiving, based on transmitting the registration message, security context information, where transmitting the first request message is based on outputting the security context information.

In some examples, the one or more RAN configuration states include RAN operation parameters, RAN status information, or both.

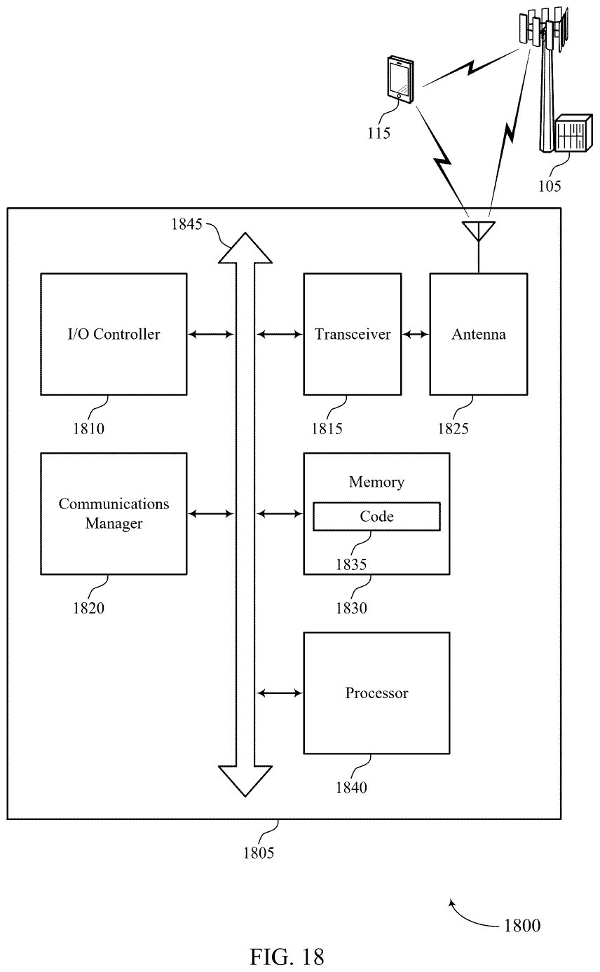

FIG. 18 shows a diagram of a system 1800 including a device 1805 that supports methods for radio access network configuration exposure and subscription in accordance with one or more aspects of the present disclosure. The device 1805 may be an example of or include components of a device 1505, a device 1605, or a UE 115 as described herein. The device 1805 may communicate (e.g., wirelessly) with one or more other devices (e.g., network entities 105, UEs 115, or a combination thereof). The device 1805 may include components for bi-directional voice and data communications including components for transmitting and receiving communications, such as a communications manager 1820, an input/output (I/O) controller, such as an I/O controller 1810, a transceiver 1815, one or more antennas 1825, at least one memory 1830, code 1835, and at least one processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOS®, ANDROID®, MS-DOS®, MS-WINDOWS®, OS/2®, UNIX®, LINUX®, or another known operating system. Additionally, or alternatively, the I/O controller 1810 may represent or interact with a modem, a keyboard, a mouse, a touchscreen, or a similar device. In some cases, the I/O controller 1810 may be implemented as part of one or more processors, such as the at least one processor 1840. In some cases, a user may interact with the device 1805 via the I/O controller 1810 or via hardware components controlled by the I/O controller 1810.

In some cases, the device 1805 may include a single antenna. However, in some other cases, the device 1805 may have more than one antenna, which may be capable of concurrently transmitting or receiving multiple wireless transmissions. The transceiver 1815 may communicate bi-directionally via the one or more antennas 1825 using wired or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The at least one memory 1830 may include random access memory (RAM) and read-only memory (ROM). The at least one memory 1830 may store computer-readable, computer-executable, or processor-executable code, such as the code 1835. The code 1835 may include instructions that, when executed by the at least one processor 1840, cause the device 1805 to perform various functions described herein. The code 1835 may be stored in a non-transitory computer-readable medium such as system memory or another type of memory. In some cases, the code 1835 may not be directly executable by the at least one processor 1840 but may cause a computer (e.g., when compiled and executed) to perform functions described herein. In some cases, the at least one memory 1830 may include, among other things, a basic I/O system (BIOS) which may control basic hardware or software operation such as the interaction with peripheral components or devices.

The at least one processor 1840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1840 may be configured to operate a memory array using a memory controller. In some other cases, a memory controller may be integrated into the at least one processor 1840. The at least one processor 1840 may be configured to execute computer-readable instructions stored in a memory (e.g., the at least one memory 1830) to cause the device 1805 to perform various functions (e.g., functions or tasks supporting methods for radio access network configuration exposure and subscription). For example, the device 1805 or a component of the device 1805 may include at least one processor 1840 and at least one memory 1830 coupled with or to the at least one processor 1840, the at least one processor 1840 and the at least one memory 1830 configured to perform various functions described herein.

In some examples, the at least one processor 1840 may include multiple processors and the at least one memory 1830 may include multiple memories. One or more of the multiple processors may be coupled with one or more of the multiple memories, which may, individually or collectively, be configured to perform various functions described herein. In some examples, the at least one processor 1840 may be a component of a processing system, which may refer to a system (such as a series) of machines, circuitry (including, for example, one or both of processor circuitry (which may include the at least one processor 1840) and memory circuitry (which may include the at least one memory 1830)), or components, that receives or obtains inputs and processes the inputs to produce, generate, or obtain a set of outputs. The processing system may be configured to perform one or more of the functions described herein. For example, the at least one processor 1840 or a processing system including the at least one processor 1840 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code 1835 (e.g., processor-executable code) stored in the at least one memory 1830 or otherwise, to perform one or more of the functions described herein.

The communications manager 1820 may support wireless communications in accordance with examples as disclosed herein. For example, the communications manager 1820 is capable of, configured to, or operable to support a means for transmitting, to a network entity, a first request message requesting information associated with one or more RAN configuration states of a RAN. The communications manager 1820 is capable of, configured to, or operable to support a means for receiving, from the network entity based on transmitting the first request message, a first response message indicating that the information associated with the one or more RAN configuration states of the RAN is supported.

By including or configuring the communications manager 1820 in accordance with examples as described herein, the device 1805 may support techniques for reduced latency, more efficient utilization of communication resources, and improved coordination between devices, among other examples.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the at least one processor 1840, the at least one memory 1830, the code 1835, or any combination thereof. For example, the code 1835 may include instructions executable by the at least one processor 1840 to cause the device 1805 to perform various aspects of methods for radio access network configuration exposure and subscription as described herein, or the at least one processor 1840 and the at least one memory 1830 may be otherwise configured to, individually or collectively, perform or support such operations.

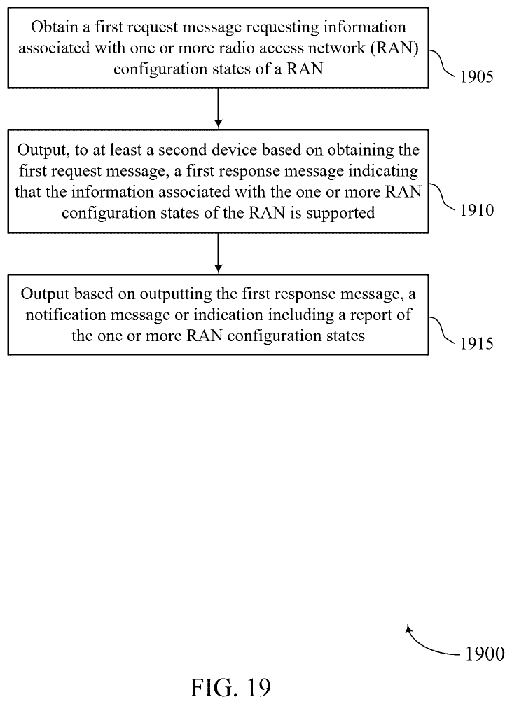

FIG. 19 shows a flowchart illustrating a method 1900 that supports methods for radio access network configuration exposure and subscription in accordance with one or more aspects of the present disclosure. The operations of the method 1900 may be implemented by a network entity or its components as described herein. For example, the operations of the method 1900 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a first request message requesting information associated with one or more RAN configuration states of a RAN. The operations of 1905 may be performed in accordance with examples as disclosed herein. In some examples, aspects of the operations of 1905 may be performed by a configuration request manager 1325 as described with reference to FIG. 13.

At 1910, the method may include outputting, to at least a second device based on obtaining the first request message, a first response message indicating that the information associated with the one or more RAN configuration states of the RAN is supported. The operations of 1910 may be performed in accordance with examples as disclosed herein. In some examples, aspects of the operations of 1910 may be performed by a supported configuration manager 1330 as described with reference to FIG. 13.

At 1915, the method may include outputting based on outputting the first response message, a notification message or indication including a report of the one or more RAN configuration states. The operations of 1915 may be performed in accordance with examples as disclosed herein. In some examples, aspects of the operations of 1915 may be performed by a configuration notification manager 1335 as described with reference to FIG. 13.

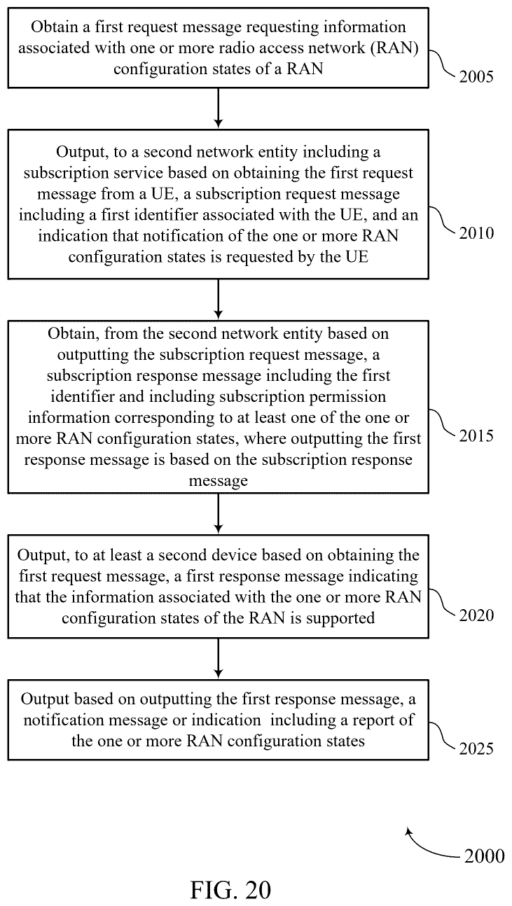

FIG. 20 shows a flowchart illustrating a method 2000 that supports methods for radio access network configuration exposure and subscription in accordance with one or more aspects of the present disclosure. The operations of the method 2000 may be implemented by a network entity or its components as described herein. For example, the operations of the method 2000 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 2005, the method may include obtaining a first request message requesting information associated with one or more RAN configuration states of a RAN. The operations of 2005 may be performed in accordance with examples as disclosed herein. In some examples, aspects of the operations of 2005 may be performed by a configuration request manager 1325 as described with reference to FIG. 13.

At 2010, the method may include outputting, to a second network entity including a subscription service based on obtaining the first request message from a UE, a subscription request message including a first identifier associated with the UE, and an indication that notification of the one or more RAN configuration states is requested by the UE. The operations of 2010 may be performed in accordance with examples as disclosed herein. In some examples, aspects of the operations of 2010 may be performed by a subscription manager 1340 as described with reference to FIG. 13.

At 2015, the method may include obtaining, from the second network entity based on outputting the subscription request message, a subscription response message including the first identifier and including subscription permission information corresponding to at least one of the one or more RAN configuration states, where outputting the first response message is based on the subscription response message. The operations of 2015 may be performed in accordance with examples as disclosed herein. In some examples, aspects of the operations of 2015 may be performed by a subscription manager 1340 as described with reference to FIG. 13.

At 2020, the method may include outputting, to at least a second device based on obtaining the first request message, a first response message indicating that the information associated with the one or more RAN configuration states of the RAN is supported. The operations of 2020 may be performed in accordance with examples as disclosed herein. In some examples, aspects of the operations of 2020 may be performed by a supported configuration manager 1330 as described with reference to FIG. 13.

At 2025, the method may include outputting based on outputting the first response message, a notification message or indication including a report of the one or more RAN configuration states. The operations of 2025 may be performed in accordance with examples as disclosed herein. In some examples, aspects of the operations of 2025 may be performed by a configuration notification manager 1335 as described with reference to FIG. 13.

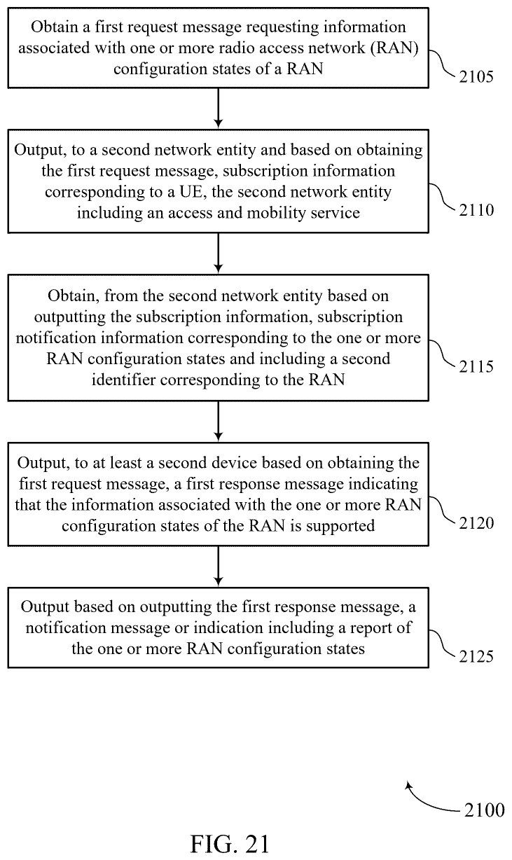

FIG. 21 shows a flowchart illustrating a method 2100 that supports methods for radio access network configuration exposure and subscription in accordance with one or more aspects of the present disclosure. The operations of the method 2100 may be implemented by a network entity or its components as described herein. For example, the operations of the method 2100 may be performed by a network entity as described with reference to FIGS. 1 through 14. In some examples, a network entity may execute a set of instructions to control the functional elements of the network entity to perform the described functions. Additionally, or alternatively, the network entity may perform aspects of the described functions using special-purpose hardware.

At 2105, the method may include obtaining a first request message requesting information associated with one or more RAN configuration states of a RAN. The operations of 2105 may be performed in accordance with examples as disclosed herein. In some examples, aspects of the operations of 2105 may be performed by a configuration request manager 1325 as described with reference to FIG. 13.

At 2110, the method may include outputting, to a second network entity and based on obtaining the first request message, subscription information corresponding to a UE, the second network entity including an access and mobility service. The operations of 2110 may be performed in accordance with examples as disclosed herein. In some examples, aspects of the operations of 2110 may be performed by a subscription manager 1340 as described with reference to FIG. 13.

At 2115, the method may include obtaining, from the second network entity based on outputting the subscription information, subscription notification information corresponding to the one or more RAN configuration states and including a second identifier corresponding to the RAN. The operations of 2115 may be performed in accordance with examples as disclosed herein. In some examples, aspects of the operations of 2115 may be performed by a subscription manager 1340 as described with reference to FIG. 13.

At 2120, the method may include outputting, to at least a second device based on obtaining the first request message, a first response message indicating that the information associated with the one or more RAN configuration states of the RAN is supported. The operations of 2120 may be performed in accordance with examples as disclosed herein. In some examples, aspects of the operations of 2120 may be performed by a supported configuration manager 1330 as described with reference to FIG. 13.

At 2125, the method may include outputting based on outputting the first response message, a notification message or indication including a report of the one or more RAN configuration states. The operations of 2125 may be performed in accordance with examples as disclosed herein. In some examples, aspects of the operations of 2125 may be performed by a configuration notification manager 1335 as described with reference to FIG. 13.

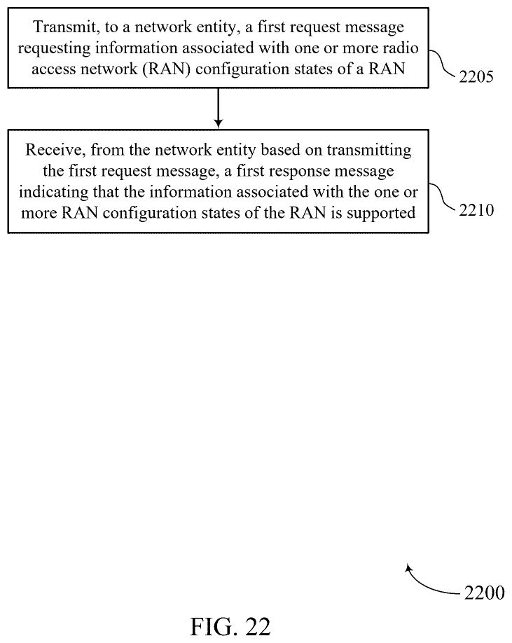

FIG. 22 shows a flowchart illustrating a method 2200 that supports methods for radio access network configuration exposure and subscription in accordance with one or more aspects of the present disclosure. The operations of the method 2200 may be implemented by a UE or its components as described herein. For example, the operations of the method 2200 may be performed by a UE 115 as described with reference to FIGS. 1 through 10 and 15 through 18. In some examples, a UE may execute a set of instructions to control the functional elements of the UE to perform the described functions. Additionally, or alternatively, the UE may perform aspects of the described functions using special-purpose hardware.

At 2205, the method may include transmitting, to a network entity, a first request message requesting information associated with one or more RAN configuration states of a RAN. The operations of 2205 may be performed in accordance with examples as disclosed herein. In some examples, aspects of the operations of 2205 may be performed by a configuration request component 1725 as described with reference to FIG. 17.

At 2210, the method may include receiving, from the network entity based on transmitting the first request message, a first response message indicating that the information associated with the one or more RAN configuration states of the RAN is supported. The operations of 2210 may be performed in accordance with examples as disclosed herein. In some examples, aspects of the operations of 2210 may be performed by a supported configuration component 1730 as described with reference to FIG. 17.

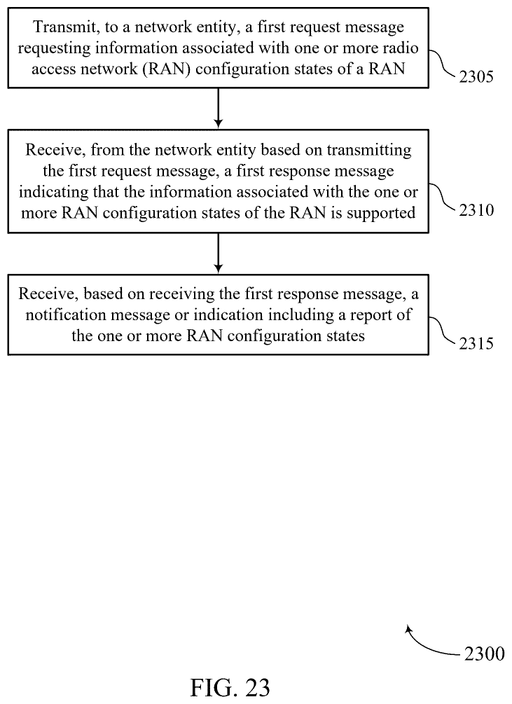

FIG. 23 shows a flowchart illustrating a method 2300 that supports methods for radio access network configuration exposure and subscription in accordance with one or more aspects of the present disclosure. The operations of the method 2300 may be implemented by a UE or its components as described herein. For example, the operations of the method 2300 may be performed by a UE 115 as described with reference to FIGS. 1 through 10 and 15 through 18. In some examples, a UE may execute a set of instructions to control the functional elements of the UE to perform the described functions. Additionally, or alternatively, the UE may perform aspects of the described functions using special-purpose hardware.

At 2305, the method may include transmitting, to a network entity, a first request message requesting information associated with one or more RAN configuration states of a RAN. The operations of 2305 may be performed in accordance with examples as disclosed herein. In some examples, aspects of the operations of 2305 may be performed by a configuration request component 1725 as described with reference to FIG. 17.

At 2310, the method may include receiving, from the network entity based on transmitting the first request message, a first response message indicating that the information associated with the one or more RAN configuration states of the RAN is supported. The operations of 2310 may be performed in accordance with examples as disclosed herein. In some examples, aspects of the operations of 2310 may be performed by a supported configuration component 1730 as described with reference to FIG. 17.

At 2315, the method may include receiving, based on receiving the first response message, a notification message or indication including a report of the one or more RAN configuration states. The operations of 2315 may be performed in accordance with examples as disclosed herein. In some examples, aspects of the operations of 2315 may be performed by a configuration status component 1735 as described with reference to FIG. 17.

The following provides an overview of aspects of the present disclosure:

Aspect 1: A method for wireless communications at a network entity comprising a network exposure service, the method comprising: obtaining a first request message requesting information associated with one or more RAN configuration states of a RAN; outputting, to at least a second device based at least in part on obtaining the first request message, a first response message indicating that the information associated with the one or more RAN configuration states of the RAN is supported; and outputting based at least in part on outputting the first response message, a notification message or indication comprising a report of the one or more RAN configuration states.

Aspect 2: The method of aspect 1, further comprising: outputting, to a second network entity comprising a subscription service based at least in part on obtaining the first request message from a UE, a subscription request message comprising a first identifier associated with the UE, and an indication that notification of the one or more RAN configuration states is requested by the UE; and obtaining, from the second network entity based at least in part on outputting the subscription request message, a subscription response message comprising the first identifier and comprising subscription permission information corresponding to at least one of the one or more RAN configuration states, wherein outputting the first response message is based at least in part on the subscription response message.

Aspect 3: The method of aspect 2, further comprising: obtaining, from the second device comprising a UE, a registration message comprising a request to establish service for the UE; outputting, based at least in part on obtaining the registration message, a security setup request message to a third network entity comprising a security service; obtaining, from the third network entity based at least in part on outputting the security setup request message, security context information; and outputting the security context information to a UE, wherein obtaining the first request message is based at least in part on outputting the security context information.

Aspect 4: The method of aspect 2, further comprising: outputting, to the RAN based at least in part on obtaining the subscription response message, an activation request message corresponding to the one or more RAN configuration states; and obtaining, from the RAN based at least in part on the activation request message, an activation response message for at least one of the one or more RAN configuration states, wherein outputting the first response message is based at least in part on the activation response message, and wherein the second device comprises a UE.

Aspect 5: The method of aspect 1, further comprising: outputting, to a second network entity and based at least in part on obtaining the first request message, subscription information corresponding to a UE, the second network entity comprising an AMS; and obtaining, from the second network entity based at least in part on outputting the subscription information, subscription notification information corresponding to the one or more RAN configuration states and comprising a second identifier corresponding to the RAN.

Aspect 6: The method of aspect 5, further comprising: outputting, to the RAN based at least in part on the second identifier, a second request message requesting the information associated with the one or more RAN configuration states of the RAN; and obtaining, from the RAN based at least in part on outputting the second request message to at least the second device, a second response message indicating that the information associated with the one or more RAN configuration states of the RAN is supported, wherein the second device comprises the UE, and wherein outputting the first response message to the UE is based at least in part on obtaining the second response message from the RAN.

Aspect 7: The method of any of aspects 5 through 6, further comprising: obtaining, from the RAN based at least in part on outputting the first response message, an indication of the report of the one or more RAN configuration states, wherein outputting the notification message or indication is based at least in part on obtaining the indication of the report.

Aspect 8: The method of any of aspects 6 through 7, wherein the second device comprises the UE, and outputting the first response message to the UE comprises outputting the first response message to the UE via an application function (AF) or a network function (NF), a network exposure service, or any combination thereof, and outputting the first response message is based at least in part on obtaining a second response message from the RAN indicating that the information associated with the one or more RAN configuration states of the RAN is supported.

Aspect 9: The method of any of aspects 1 through 8, wherein the one or more RAN configuration states comprise a codebook index, an antenna configuration, a beam shape, one or more mobility parameters, a cell activation state, a cell deactivation state, a RAN loading configuration, or any combination thereof.

Aspect 10: The method of any of aspects 1 through 9, wherein the one or more RAN configuration states comprise RAN operation parameters, RAN status information, or both.

Aspect 11: A method for wireless communications at a UE, comprising: transmitting, to a network entity, a first request message requesting information associated with one or more RAN configuration states of a RAN; and receiving, from the network entity based at least in part on transmitting the first request message, a first response message indicating that the information associated with the one or more RAN configuration states of the RAN is supported.

Aspect 12: The method of aspect 11, further comprising: receiving, based at least in part on receiving the first response message, a notification message or indication comprising a report of the one or more RAN configuration states.

Aspect 13: The method of aspect 11, wherein the first request message requests the information associated with a plurality of RAN configuration states of the RAN, and the first response message indicates that a subset of the plurality of RAN configuration states is supported.

Aspect 14: The method of aspect 11, further comprising: determining the one or more RAN configuration states of the RAN based on one or more conditions at the UE, wherein transmitting the first request message is based at least in part on the determining.

Aspect 15: The method of any of aspects 11 through 14, wherein the one or more RAN configuration states comprise a codebook index, an antenna configuration, a beam shape, one or more mobility parameters, a cell activation state, a cell deactivation state, a RAN loading configuration, or any combination thereof.

Aspect 16: The method of any of aspects 11 through 13, wherein the network entity comprises a RAN, a RAN exposure service, a network exposure service, a subscription service, an AMS, or any combination thereof.

Aspect 17: The method of aspect 11, further comprising: transmitting a registration message comprising a request to establish service for the UE; and receiving, based at least in part on transmitting the registration message, security context information, wherein transmitting the first request message is based at least in part on outputting the security context information.

Aspect 18: The method of any of aspects 11 through 17, wherein the one or more RAN configuration states comprise RAN operation parameters, RAN status information, or both.

Aspect 19: A network entity comprising a network exposure service for wireless communications, comprising one or more memories storing processor-executable code, and one or more processors coupled with the one or more memories and individually or collectively operable to execute the code to cause the network entity comprising a network exposure service to perform a method of any of aspects 1 through 10.

Aspect 20: A network entity comprising a network exposure service for wireless communications, comprising at least one means for performing a method of any of aspects 1 through 10.

Aspect 21: A non-transitory computer-readable medium storing code for wireless communications, the code comprising instructions executable by one or more processors to perform a method of any of aspects 1 through 10.

Aspect 22: A UE for wireless communications, comprising one or more memories storing processor-executable code, and one or more processors coupled with the one or more memories and individually or collectively operable to execute the code to cause the UE to perform a method of any of aspects 11 through 18.

Aspect 23: A UE for wireless communications, comprising at least one means for performing a method of any of aspects 11 through 18.

Aspect 24: A non-transitory computer-readable medium storing code for wireless communications, the code comprising instructions executable by one or more processors to perform a method of any of aspects 11 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity comprising a network exposure service, comprising:
one or more memories, wherein the one or more memories comprise processor-executable code; and
one or more processors coupled with the one or more memories and individually or collectively operable to execute the code to cause the network entity to:
obtain a first request message requesting information associated with one or more radio access network (RAN) configuration states of a RAN;
output, to at least a second device based at least in part on obtaining the first request message, a first response message indicating that the information associated with the one or more RAN configuration states of the RAN is supported; and
output based at least in part on outputting the first response message, a notification message or indication comprising a report of the one or more RAN configuration states.

2. The network entity of claim 1, wherein the one or more processors are individually or collectively further operable to execute the code to cause the network entity to:
output, to a second network entity comprising a subscription service based at least in part on obtaining the first request message from a user equipment (UE), a subscription request message comprising a first identifier associated with the UE, and an indication that notification of the one or more RAN configuration states is requested by the UE; and
obtain, from the second network entity based at least in part on outputting the subscription request message, a subscription response message comprising the first identifier and comprising subscription permission information corresponding to at least one of the one or more RAN configuration states, wherein outputting the first response message is based at least in part on the subscription response message.

3. The network entity of claim 2, wherein the one or more processors are individually or collectively further operable to execute the code to cause the network entity to:
obtain, from the second device comprising a UE, a registration message comprising a request to establish service for the UE;
output, based at least in part on obtaining the registration message, a security setup request message to a third network entity comprising a security service;
obtain, from the third network entity based at least in part on outputting the security setup request message, security context information; and
output the security context information to a user equipment (UE), wherein obtaining the first request message is based at least in part on outputting the security context information.

4. The network entity of claim 2, wherein the one or more processors are individually or collectively further operable to execute the code to cause the network entity to:
output, to the RAN based at least in part on obtaining the subscription response message, an activation request message corresponding to the one or more RAN configuration states; and
obtain, from the RAN based at least in part on the activation request message, an activation response message for at least one of the one or more RAN configuration states, wherein outputting the first response message is based at least in part on the activation response message, and wherein the second device comprises a user equipment (UE).

5. The network entity of claim 1, wherein the one or more processors are individually or collectively further operable to execute the code to cause the network entity to:
output, to a second network entity and based at least in part on obtaining the first request message, subscription information corresponding to a user equipment (UE), the second network entity comprising an access and mobility service; and
obtain, from the second network entity based at least in part on outputting the subscription information, subscription notification information corresponding to the one or more RAN configuration states and comprising a second identifier corresponding to the RAN.

6. The network entity of claim 5, wherein the one or more processors are individually or collectively further operable to execute the code to cause the network entity to:
output, to the RAN based at least in part on the second identifier, a second request message requesting the information associated with the one or more RAN configuration states of the RAN; and
obtain, from the RAN based at least in part on outputting the second request message to at least the second device, a second response message indicating that the information associated with the one or more RAN configuration states of the RAN is supported, wherein the second device comprises the UE, and wherein outputting the first response message to the UE is based at least in part on obtaining the second response message from the RAN.

7. The network entity of claim 5, wherein the one or more processors are individually or collectively further operable to execute the code to cause the network entity to:
obtain, from the RAN based at least in part on outputting the first response message, an indication of the report of the one or more RAN configuration states, wherein outputting the notification message or indication is based at least in part on obtaining the indication of the report.

8. The network entity of claim 5, wherein:
the second device comprises the UE, and outputting the first response message to the UE comprises outputting the first response message to the UE via an application function (AF) or a network function (NF), a network exposure service, or any combination thereof, and outputting the first response message is based at least in part on obtaining a second response message from the RAN indicating that the information associated with the one or more RAN configuration states of the RAN is supported.

9. The network entity of claim 1, wherein the one or more RAN configuration states comprise a codebook index, an antenna configuration, a beam shape, one or more mobility parameters, a cell activation state, a cell deactivation state, a RAN loading configuration, or any combination thereof.

10. The network entity of claim 1, wherein the one or more RAN configuration states comprise RAN operation parameters, RAN status information, or both.

11. A user equipment (UE), comprising:
one or more memories, wherein the one or more memories comprise processor-executable code; and
one or more processors coupled with the one or more memories and individually or collectively operable to execute the code to cause the UE to:
transmit, to a network entity, a first request message requesting information associated with one or more radio access network (RAN) configuration states of a RAN; and
receive, from the network entity based at least in part on transmitting the first request message, a first response message indicating that the information associated with the one or more RAN configuration states of the RAN is supported.

12. The UE of claim 11, wherein the one or more processors are individually or collectively further operable to execute the code to cause the UE to:
receive, based at least in part on receiving the first response message, a notification message or indication comprising a report of the one or more RAN configuration states.

13. The UE of claim 11, wherein the first request message requests the information associated with a plurality of RAN configuration states of the RAN, and the first response message indicates that a subset of the plurality of RAN configuration states is supported.

14. The UE of claim 11, wherein the one or more processors are individually or collectively further operable to execute the code to cause the UE to:
determine the one or more RAN configuration states of the RAN based on one or more conditions at the UE, wherein transmitting the first request message is based at least in part on the determining.

15. The UE of claim 11, wherein the one or more RAN configuration states comprise a codebook index, an antenna configuration, a beam shape, one or more mobility parameters, a cell activation state, a cell deactivation state, a RAN loading configuration, or any combination thereof.

16. The UE of claim 11, wherein the network entity comprises a RAN, a RAN exposure service, a network exposure service, a subscription service, an access and mobility service, or any combination thereof.

17. The UE of claim 11, wherein the one or more processors are individually or collectively further operable to execute the code to cause the UE to:
transmit a registration message comprising a request to establish service for the UE; and
receive, based at least in part on transmitting the registration message, security context information, wherein transmitting the first request message is based at least in part on outputting the security context information.

18. The UE of claim 11, wherein the one or more RAN configuration states comprise RAN operation parameters, RAN status information, or both.

19. A method for wireless communications at a network entity comprising a network exposure service, the method comprising:
obtaining a first request message requesting information associated with one or more radio access network (RAN) configuration states of a RAN;
outputting, to at least a second device based at least in part on obtaining the first request message, a first response message indicating that the information associated with the one or more RAN configuration states of the RAN is supported; and
outputting based at least in part on outputting the first response message, a notification message or indication comprising a report of the one or more RAN configuration states.

20. The method of claim 19, further comprising:
outputting, to a second network entity comprising a subscription service based at least in part on obtaining the first request message from a user equipment (UE), a subscription request message comprising a first identifier associated with the UE, and an indication that notification of the one or more RAN configuration states is requested by the UE; and
obtaining, from the second network entity based at least in part on outputting the subscription request message, a subscription response message comprising the first identifier and comprising subscription permission information corresponding to at least one of the one or more RAN configuration states, wherein outputting the first response message is based at least in part on the subscription response message.

21. The method of claim 20, further comprising:
obtaining, from the second device comprising a UE, a registration message comprising a request to establish service for the UE;
outputting, based at least in part on obtaining the registration message, a security setup request message to a third network entity comprising a security service;
obtaining, from the third network entity based at least in part on outputting the security setup request message, security context information; and
outputting the security context information to a user equipment (UE), wherein obtaining the first request message is based at least in part on outputting the security context information.

22. The method of claim 20, further comprising:
outputting, to the RAN based at least in part on obtaining the subscription response message, an activation request message corresponding to the one or more RAN configuration states; and
obtaining, from the RAN based at least in part on the activation request message, an activation response message for at least one of the one or more RAN configuration states, wherein outputting the first response message is based at least in part on the activation response message, and wherein the second device comprises a user equipment (UE).

23. The method of claim 19, further comprising:
outputting, to a second network entity and based at least in part on obtaining the first request message, subscription information corresponding to a user equipment (UE), the second network entity comprising an access and mobility service; and
obtaining, from the second network entity based at least in part on outputting the subscription information, subscription notification information corresponding to the one or more RAN configuration states and comprising a second identifier corresponding to the RAN.

24. The method of claim 23, further comprising:
outputting, to the RAN based at least in part on the second identifier, a second request message requesting the information associated with the one or more RAN configuration states of the RAN; and
obtaining, from the RAN based at least in part on outputting the second request message to at least the second device, a second response message indicating that the information associated with the one or more RAN configuration states of the RAN is supported, wherein the second device comprises the UE, and wherein outputting the first response message to the UE is based at least in part on obtaining the second response message from the RAN.

25. The method of claim 23, further comprising:
obtaining, from the RAN based at least in part on outputting the first response message, an indication of the report of the one or more RAN configuration states, wherein outputting the notification message or indication is based at least in part on obtaining the indication of the report.

26. The method of claim 23, wherein:
the second device comprises the UE, and outputting the first response message to the UE comprises outputting the first response message to the UE via an application function (AF) or a network function (NF), a network exposure service, or any combination thereof, and outputting the first response message is based at least in part on obtaining a second response message from the RAN indicating that the information associated with the one or more RAN configuration states of the RAN is supported.

27. The method of claim 19, wherein the one or more RAN configuration states comprise a codebook index, an antenna configuration, a beam shape, one or more mobility parameters, a cell activation state, a cell deactivation state, a RAN loading configuration, or any combination thereof.

28. The method of claim 19, wherein the one or more RAN configuration states comprise RAN operation parameters, RAN status information, or both.

29. A method for wireless communications at a user equipment (UE), comprising:
transmitting, to a network entity, a first request message requesting information associated with one or more radio access network (RAN) configuration states of a RAN; and
receiving, from the network entity based at least in part on transmitting the first request message, a first response message indicating that the information associated with the one or more RAN configuration states of the RAN is supported.

30. The method of claim 29, further comprising:
receiving, based at least in part on receiving the first response message, a notification message or indication comprising a report of the one or more RAN configuration states.
